(19) United States
(12) Patent Application Publication
(10) Pub. No.: US 2024/0083628 A1
(43) Pub. Date: Mar. 14, 2024

(54) MULTI-COMPARTMENT CONTAINERS

(71) Applicant: Gerry Gersovitz, San Francisco, CA (US)

(72) Inventor: Gerry Gersovitz, San Francisco, CA (US)

(21) Appl. No.: 18/371,407

(22) Filed: Sep. 21, 2023

Related U.S. Application Data
(63) Continuation of application No. 17/189,101, filed on Mar. 1, 2021, now abandoned.
Application No. 17/189,101 is a continuation-in-part of application No. 16/457,434, filed on Jun. 28, 2019, now Pat. No. 11,225,357.
Application No. 16/457,434 is a continuation-in-part of application No. 15/434,988, filed on Feb. 16, 2017, now Pat. No. 10,442,569.
Application No. 15/434,988 is a continuation of application No. 14/542,507, filed on Nov. 14, 2014, now Pat. No. 9,611,073.
Application No. 14/542,507 is a division of application No. 12/622,853, filed on Nov. 20, 2009, now Pat. No. 8,915,395.
Application No. 12/622,853 is a continuation-in-part of application No. 12/415,910, filed on Mar. 31, 2009, now abandoned.
Application No. 12/415,910 is a division of application No. 10/948,837, filed on Sep. 22, 2004, now Pat. No. 7,571,829.
Application No. 17/189,101 is a continuation-in-part of application No. 14/692,765, filed on Apr. 22, 2015, now Pat. No. 9,337,798.
Application No. 14/692,765 is a division of application No. 13/093,468, filed on Apr. 25, 2011, now abandoned.
(60) Provisional application No. 60/505,410, filed on Sep. 23, 2003.
(60) Provisional application No. 61/345,974, filed on May 18, 2010.

(51) Int. Cl. B65D 21/02; B65B 5/04; B65B 7/28; B65D 51/20

(52) U.S. Cl. CPC B65D 21/0227; B65B 5/04; B65B 7/28; B65D 21/0224; B65D 51/20; B65D 25/04; B65D 2251/0093

(57) ABSTRACT

Described herein are multi-unit storage devices where two separate compartments are joined in a manner such that accessing one of the compartments does not compromise product held in the other compartment. The separate compartments may be vacuum or otherwise sealed such that when the seal is broken, access to the products contained therein is provided. Each of the compartments may be independently sealed.

### CROSS-REFERENCES TO RELATED APPLICATIONS

This application is a continuation of U.S. patent application Ser. No. 17/189,101, filed Mar. 1, 2021, which is a continuation-in-part of U.S. patent application Ser. No. 16/457,434, filed Jun. 28, 2019, which is a continuation-in-part of U.S. patent application Ser. No. 15/434,988, filed on Feb. 16, 2017 (now issued as U.S. Pat. No. 10,442,569), which is a continuation of U.S. patent application Ser. No. 14/542,507, filed on Nov. 14, 2014 (now issued as U.S. Pat. No. 9,611,073), which is divisional of U.S. patent application Ser. No. 12/622,853, filed on Nov. 20, 2009 (now issued as U.S. Pat. No. 8,915,395), which is a continuation-in-part of U.S. patent application Ser. No. 12/415,910, filed on Mar. 31, 2009 (now abandoned), which is a divisional of U.S. patent application Ser. No. 10/948,837, filed on Sep. 22, 2004 (now issued as U.S. Pat. No. 7,571,829), which claims priority to Provisional Application No. 60/505,410, filed on Sep. 23, 2003. This Application is also a continuation-in-part of U.S. patent application Ser. No. 14/693,765, filed on Apr. 22, 2015, which is a divisional of U.S. application Ser. No. 13/093,468, filed Apr. 25, 2011 (now abandoned), which claims priority and benefit from U.S. Provisional Application No. 61/345,974, filed May 18, 2010. This application also claims priority to Provisional Application No. 62/984,222, filed Mar. 2, 2020. The disclosures of each of the applications above are incorporated herein by reference in their entirety for all purposes.

### BACKGROUND

Examples described herein relate to packaging for consumer and commercial products that can lose potency or freshness when the package is opened and the contents are exposed to atmospheric conditions, such as oxygen and moisture in air. While such problems are present in traditional sizes and portions, they are a particularly pronounced in products that are typically purchased in “bulk” or “economy” sizes or take some amount of time to use or consume once the package has been opened. The amount of product or size of the portion that is considered “bulk” or “economy” sizes can depend on the nature of the product. For example, ground coffee can quickly lose its aromatic oils when exposed to air, while other dry goods, such as dry rice and dried beans, are much more stable when exposed to air. Other products, such as baking powder, can begin losing potency immediately upon exposure to air. Accordingly, the amount of the product that might be considered “bulk” or “economy” size can vary with the type of the product and its ability to maintain freshness upon exposure to air.

One particular problem with “bulk” or “economy” size single compartment packaging is that the entirety of the contents is exposed to the air once the package is opened for the first time and each time the package is accessed to remove more product. As such, the possible savings realized on a per serving or per use basis can be and are often lost due to spoilage or staleness of at least some of the product if not used in a timely manner. This problem is only exacerbated by the mandatory or voluntary removal of preservatives from many products and food stuffs.

Examples of conventional packages or containers that are used for consumer and commercial products may include a number of different types. Typical cans or canister containers, are available in various sizes and proportions and made of various materials, such as metal, plastic, cardboard, paperboard, foil, Mylar™, or a composite of any of the foregoing. Conventional boxes or cartons, similarly, are available in various sizes and proportions and made of various materials, such as metal, plastic, cardboard, paperboard or a composite or combination of any of the foregoing. Conventional bags, also are available in various sizes and proportions and made of various materials, such as paper, plastic, Mylar™, foil or a combination of any of the foregoing. Plastics can include traditional variations of polyethylene. Each individual can, box, and bag are single compartment containers. As such, each exhibit a similar problem with single compartment containers in that once they are opened, the entire contents of the container are exposed to air and moisture.

As known, exposure to air and moisture can cause many products, such as food stuffs, to lose freshness or go stale. To avoid continued exposure to air and moisture, some configurations of the container may include re-sealable or reusable lids and closures. For example, a can might include a reusable plastic lid, a box might include a re-sealable top having some type of reusable adhesive, while a bag might be equipped with a re-sealable or reusable closure like a zipper or a clip. However, such re-sealable or reusable closures still allow the entirety of the remaining contents to be exposed to new air and moisture each time the package is opened to access the product.

One particular problem with “bulk” or “economy” size single compartment packaging is that the entirety of the contents is exposed to the air once the package is opened for the first time and each time the package is accessed to remove more product. As such, the possible savings realized on a per serving or per use basis can be and are often lost due to spoilage or staleness of at least some of the product if not used in a timely manner. This problem is only exacerbated by the mandatory or voluntary removal of preservatives from many products and food stuffs.

Additionally, In the packaging of certain products where freshness is a concern, it is desirable to have the products packaged under vacuum or seal to avoid exposure to the damaging effects of the atmosphere. By way of example, one such product is coffee. Typically, coffee is packaged in a single compartment can under vacuum or with nitrogen-rich environments. When the coffee can is opened and exposed to atmospheric conditions, all of the coffee in that coffee can may lose its aroma and flavor due to the effects of oxygen and moisture in the atmosphere. Consequently, there is a need for a container that gives consumers access to an amount of sealed products without compromising the freshness of all of the contents in the container.

### BRIEF SUMMARY

Broadly, the present description provides a multi-unit storage device where two separate compartments are joined in a manner such that accessing one of the compartments does not compromise product held in the other compartment. The separate compartments may be vacuum or otherwise sealed such that when the seal is broken, access to the products contained therein is provided. Each of the compartments may be independently sealed.

In accordance with at least one example, a multi-unit storage device includes a container comprising: a first end, a second end, at least one surface extending from the first end to the second end, a divider wall defining a first compartment extending from the divider wall to the first end and a second compartment extending from the divider wall to the second end, perforations in the at least one surface that can be used to detach the first compartment from the second compartment once the contents of the first compartment are depleted, a first seal coupled to the first compartment, and a second seal coupled to the second compartment, wherein at least one of the first seal or the second seal is a reusable closure element.

In accordance with at least one example, a method of using a multi-compartment storage device includes obtaining the multi-compartment storage device, wherein the multi-compartment storage device comprises: a container having a first end, a second end, and at least one surface extending from the first end to the second end, a divider wall defining a first compartment extending from the divider wall to the first end and a second compartment extending from the divider wall to the second end, perforations in the at least one surface that can be used to detach the first compartment from the second compartment once the contents of the first compartment are depleted, a first seal coupled to the first compartment; and a second seal coupled to the second compartment, wherein at least one of the first seal or the second seal is a reusable closure element; opening the first seal; accessing and using product stored in the first compartment until depleted; opening the second seal after the product stored in the first compartment is depleted; and accessing and using product stored in the second compartment.

In accordance with one example of the present disclosure, a multi-compartment storage device, comprising: a first compartment, a second compartment, and a divider wall defining the first compartment and the second compartment, wherein each of the first compartment and the second compartment is independently accessible, perforations in the at least one surface that can be used to detach the first compartment from the second compartment once the contents of the first compartment are depleted, a first seal coupled to the first compartment, and a second seal coupled to the second compartment, wherein at least one of the first seal or the second seal can be removed without breaking the other seal.

Other features and advantages will be apparent upon review of the following detailed description of exemplary examples.

### BRIEF DESCRIPTION OF THE DRAWINGS

FIG. 1 is an elevation view of two containers for a multi-unit storage device in accordance with at least one example;

FIG. 2 is an elevation view of the two containers forming a multi-unit storage device in accordance with at least one example;

FIG. 3 is an elevation view of two cylinders and connecting-divider for a multi-unit storage device in accordance with at least one example;

FIG. 4 is an elevation view of one cylinders and connecting-divider for a multi-unit storage device in accordance with at least one example;

FIG. 5 is view of a multi-compartment container in which multiple compartments are divided via a divider wall in accordance with at least one example;

FIG. 6 shows various examples of a multi-compartment, including an example can or canister container, box, and bag or sack in accordance with at least one example;

FIG. 7 shows an example of a two compartments cereal box in accordance with at least one example;

FIG. 8 shows one example of a plastic box that may be suitable for packaging dry or wet products in accordance with at least one example;

FIG. 9 shows a multi-compartment bag in accordance with at least one example;

FIG. 10 shows an example multi-compartment container for packaging ice cream in accordance with at least one example;

FIG. 11 show an example of a multi-compartment container in accordance with at least one example;

FIG. 12 is a flowchart of a method for using a multi-compartment container in accordance with at least one example;

FIGS. 13A and 13B depicts an illustrative example of a multi-compartment used for packaging bread in accordance with at least one example;

FIG. 14 depicts an illustrative example of a divider wall for a multi-compartment container in accordance with at least one example;

FIG. 15 depicts various examples of multi-compartment containers in accordance with at least one example;

FIG. 16 depicts a view of a multi-compartment container in which multiple compartments are divided via a divider wall in accordance with at least one example;

FIG. 17 depicts variations in design which can be implemented into the multi-compartment container in accordance with at least one example;

FIG. 18 depicts an illustrative example in which the multi-compartment container is a tray having a divider in accordance with at least one example;

FIG. 19 depicts an illustrative example in which the multi-compartment container is a carton container having a divider in accordance with at least one example;

FIG. 20 depicts an illustrative example in which the multi-compartment container is a canister container having a divider in accordance with at least one example;

FIG. 21 depicts an illustrative example in which the multi-compartment container is a clamshell package having a divider that may be suitable for packaging dry or wet products in accordance with at least one example;

FIG. 22 depicts an illustrative example of a technique by which the multi-compartment container may be manipulated to provide for more secure storage in accordance with at least one example;

FIG. 23 depicts an illustrative example in which the multi-compartment container is a bag having a divider in accordance with at least one example;

FIG. 24 depicts an illustrative example of an example of a multi-compartment container in accordance with at least one example;

FIG. 25 depicts a flowchart of a method for using a multi-compartment container in accordance with at least one example; and.

FIG. 26 shows views of a multi-compartment container in accordance with at least one example.

### DETAILED DESCRIPTION

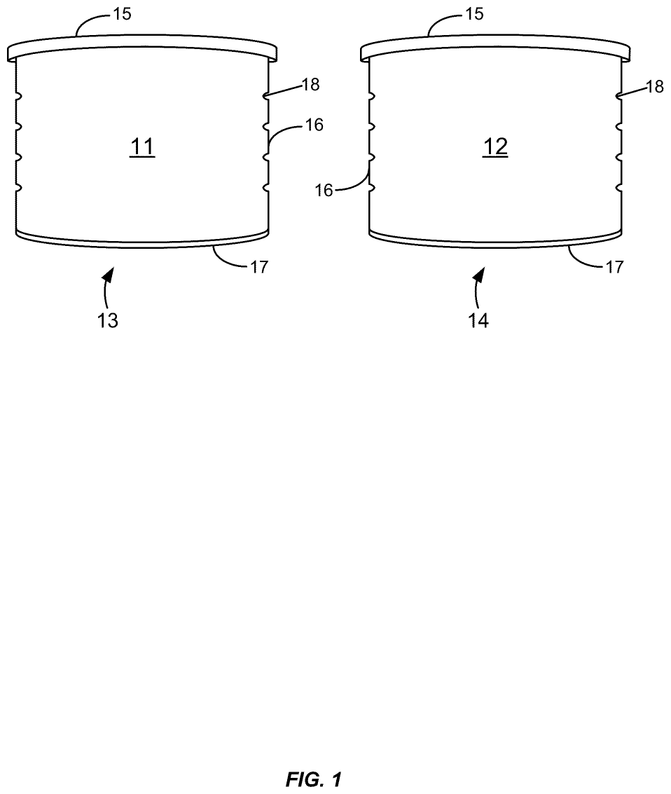

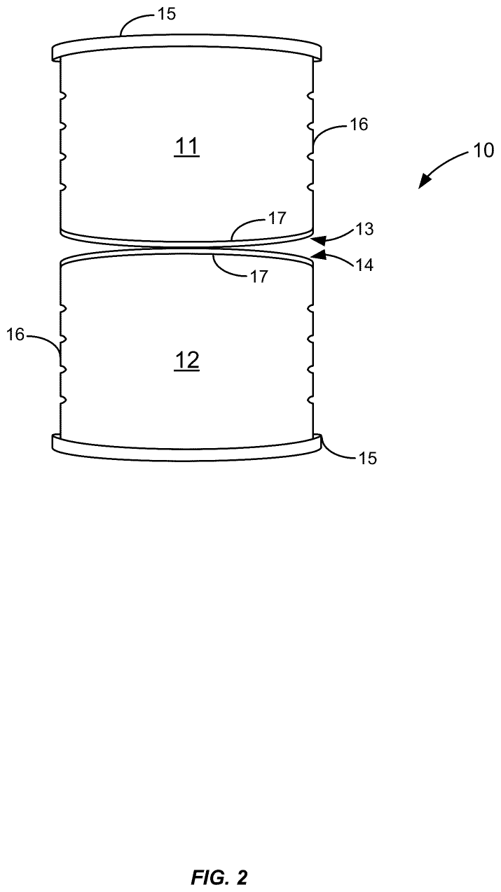

With reference to FIGS. 1 and 2, a multi-unit storage device 10 in accordance with at least one example is illustrated. The multi-unit storage device consists of two containers or cans 11, 12. The containers may be made of metal, in which case they are welded together at their bottom portions 13, 14. Glue or some other type of adhesive may also be used.

The top portions can be sealed with either metal, foil, plastic or any other suitable material. As described herein, examples of packages may be formed of any of the preceding materials or any other known materials used in packaging including recycled packaging, compostable, sustainable packaging, and other such materials. Examples for the two separate containers include coffee cans, nut cans, potato chip cans and other types of snacks. Lids 15 can be provided for closing or resealing the cans 11, 12.

The separate cans may be made using many manufacturing techniques. Early methods of making such cans included rolling a metallic body or sidewall 16 and coupling a metallic bottom 17 to the body portion with a folded or sealed flange. Additionally, the bottom may be coupled to the rolled body with a welding-type process. Modern methods include stamping or forming the bottom and body as a unitary body. In some examples, ribs or troughs 18 may be defined circumferentially in the body or sidewall to provide extra strength and stability.

Another example of a type of container that may be used as the containers to form the multi-unit storage device in accordance with the present description includes a cardboard or plastic body 16 with a metal, or plastic bottom 17. The containers may also be made as a unitary body of plastic or other suitable material. Examples of such a container include orange juice cans, nut cans, coffee, some potato snack cans and other snack cans.

In use, two containers 11, 12 as described above are provided and are coupled together at their bottom portions 13, 14. Each can, container or compartment is filled with a product and then individually vacuum, nitrogen flush or otherwise sealed. This may be done before or after the two containers are coupled to one another. Each compartment may be filled with the same product or different products. Examples of products include, but are not limited to, coffee, nuts, potato chips, candy, tea, dried fruit, etc.

When one desires access to a product, one simply opens one compartment of the container. Thus, the second compartment remains unopened, thereby protecting the product therein from the elements and helping maintain freshness. When access to the second compartment is desired, the multi-unit storage device is “flipped” and the second compartment is opened. Each compartment may be closed with lids 15 if provided. One lid may be provided and used for both containers if desired.

Additionally, each compartment may be filled with a different product if it is so desired. For example, one compartment may include potato chips while the second container may include corn chips.

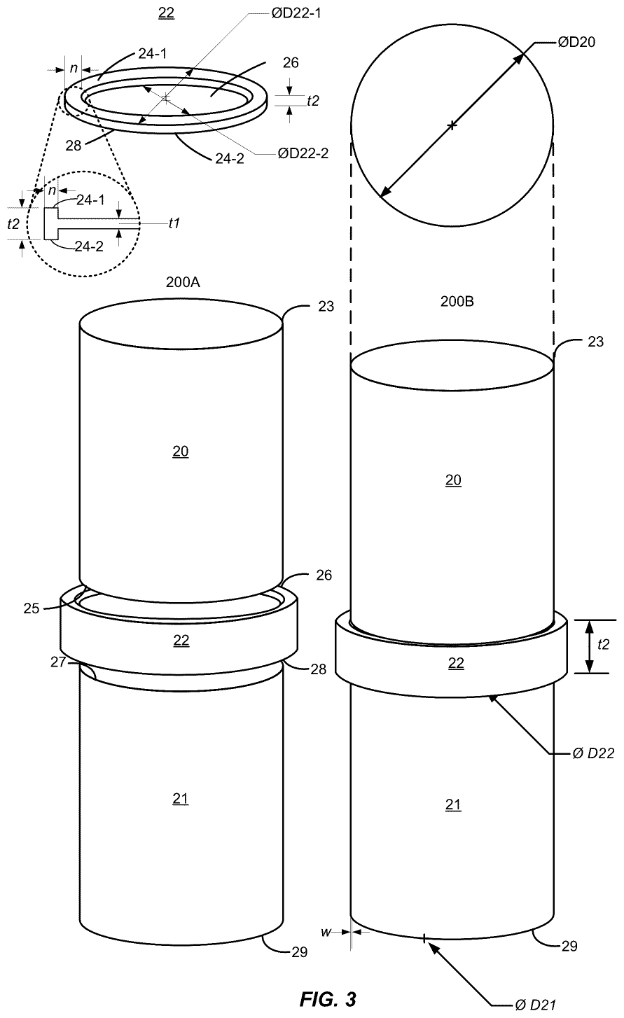

FIG. 3 shows another example of a multi-compartment container according to at least one example. Elevation view 200A is the unassembled view of the multi-compartment container in elevation view 200B. As shown in FIG. 3, multi-compartment container in elevation view 200A can include a first cylinder 20, a connecting-divider 22 and a second cylinder 21. First cylinder 20 and second cylinder 21 can be made of any number of materials including, but not limited to, metal, plastic, cardboard, paper board, Mylar® and foil. In some examples, first cylinder 20 and second cylinder 21 can be made of a composite material that incorporates two or more of the aforementioned materials. For example, the substrate of first cylinder 20 and second cylinder 21 can include a cardboard substrate having a foil lining on the interior surface of the cylinder and a Mylar® or plastic coating on the exterior surface of the cylinder. Using or reducing the amount of metal in a container can drastically reduce the cost of producing and shipping the containers. Not only are the actual non-metal component materials less expensive, but there are many inexpensive techniques and machines that may be used for producing containers, cans, cylinders and dividers from non-metal materials.

In various examples, the first end 23 of the first cylinder 20 can have a top opening portion adapted to be sealed and capable of receiving a reusable lid to close the opening. Similarly, the second end 29 of the second cylinder 21 can also have a top opening portion adapted to be sealed and capable of receiving a reusable lid to close the opening. The reusable lid can be similar to the reusable lid 15 shown in FIGS. 1 and 2. The multi-compartment container or storage device pictured in FIG. 3 can be used, filled and accessed in manners similar to those described above.

In various examples, the first cylinder 20 and second cylinder 21 are hollow cylinders with a wall thickness, w, dimensioned to produce the structural rigidity suitable for containing and protecting products packaged therein, maintaining optional vacuum or pressure or stacking of multiple containers during shipping and display. The first cylinder can include an interior surface and an exterior surface with similar or dissimilar materials. For example, the exterior surface can be coated in a plastic film while the interior surface can be coated with a metal foil. The wall thickness, w, can depend on multiple factors, such as the intended use of the multi-compartment container, the material of the cylinders and the intended packaging method. For example, the wall thickness, w, for a cardboard cylinder can be thicker than that of a metal cylinder, especially if the resulting multi-compartment container is intended to be vacuum, pressure or nitrogen flushed sealed. Nitrogen flush sealing replaces the air inside the container to remove oxygen and moisture to help better preserve the freshness of the packaged products.

First cylinder 20 can have a first end 23 and a second end 25 and second cylinder 21 can have a first end 27 and a second end 29. Connecting-divider 22 can have a first side 26 and a second side 28 and have a unitary body construction. Multi-compartment container 200B can be assembled by attaching or coupling the second end 25 of first cylinder 20 with the first side 26 of connecting-divider 22 and attaching or coupling the first end 27 of cylinder 21 to the second side 28 of connecting-divider 22. The means of attaching or coupling the ends of the two cylinders 20 and 21 to the connecting-divider 22 can include, but are not limited to, adhesive, welding and crimping or any combination thereof.

In some examples, connecting-divider 22 can have lip section 24-1 on first side 26 and lip section 24-2 on second side 28. The width, n, of lip sections 24-1 and 24-2 can be defined by the difference between the diameter D22-2 of the solid inner portion of connecting-divider 22 and the outer diameter D 22-1 of connecting-divider 22. In some examples, diameter D22-2 can be dimensioned to slip or snug fit around the outside of diameter D20 of the first cylinder 20 and the second cylinder 21. In such examples, the first cylinder 20 and the second cylinder 21 can be inserted into the region defined by the lip sections 24-1 and 24-2, respectively. The lip sections 24-1 and 24-2 can be dimensioned so that the interior surface of lip sections 24-1 and 24-2 extend around the outer surfaces of first cylinder 20 and second cylinder 21, respectively. In some examples, adhesive can be applied to the inner surface of the lip sections or the outer surface of the cylinders ends to provide more surface area of adhesion. In other examples, the lip sections can be crimped or otherwise deformed so as to grab or engage the outer surfaces of the cylinders. In other examples, adhesive and crimping can be used to ensure a strong and airtight seal between the cylinders 20, 21 and connecting-divider 22.

The height of the lip sections can be dimensioned so as to provide additional surface area on which to apply adhesive between the connecting-divider 22 and the cylinders 20 and 21 to further strengthen the connection between the components. The height of the lip section can be defined as the difference between the thickness t1 of the solid inner portion of connecting-divider 22 and thickness t2. In some examples, the inner solid section of connecting-divider 22 is symmetrically arranged between lip section 24-1 and lip section 24-2. In other examples, the inner solid section of connecting-divider 22 can be arranged asymmetrically between the two lip sections. In some examples, the lip sections 24-1 and 24-2 can dimensioned with different diameters D22-2 so as to accommodate two cylinders with different dimensions such as wall thickness and diameter. For example, first cylinder 20 can have a diameter D20 and wall thickness w while second cylinder 21 can have a diameter different from diameter D20 and a wall thickness different from w.

When fully assembled, multi-compartment container 200B can have one compartment, or container, with walls of uniform diameter defined by the inner surface of cylinder 20 and a bottom defined by the first side 26 of the solid inner portion of connecting-divider 22 and another compartment, or container, with walls defined by the inner surface of cylinder 21 and the bottom defined by the second side 28 of the solid inner portion of connecting-divider 22. In some examples, connecting-divider 22 has no lip sections and second end 25 of the first cylinder 20 and the first end 27 of the second cylinder 21, each having some wall thickness w, are coupled to the surfaces of opposite sides of the connecting-divider 22.

In other examples, in which the walls are plastic or other material, the cylinders can have non-uniform diameter from one end to the other or other arbitrary shape as determined by the aesthetics or design of the packaging. For example, the plastic walls can have depressions or impressions that make it easier to hold or handle the multi-compartment container. Similarly, the compartments can any shape required by the product or the needs of the aesthetic design with two or more separately sealable/openable compartments, i.e. the shape of a cartoon character or trademark character.

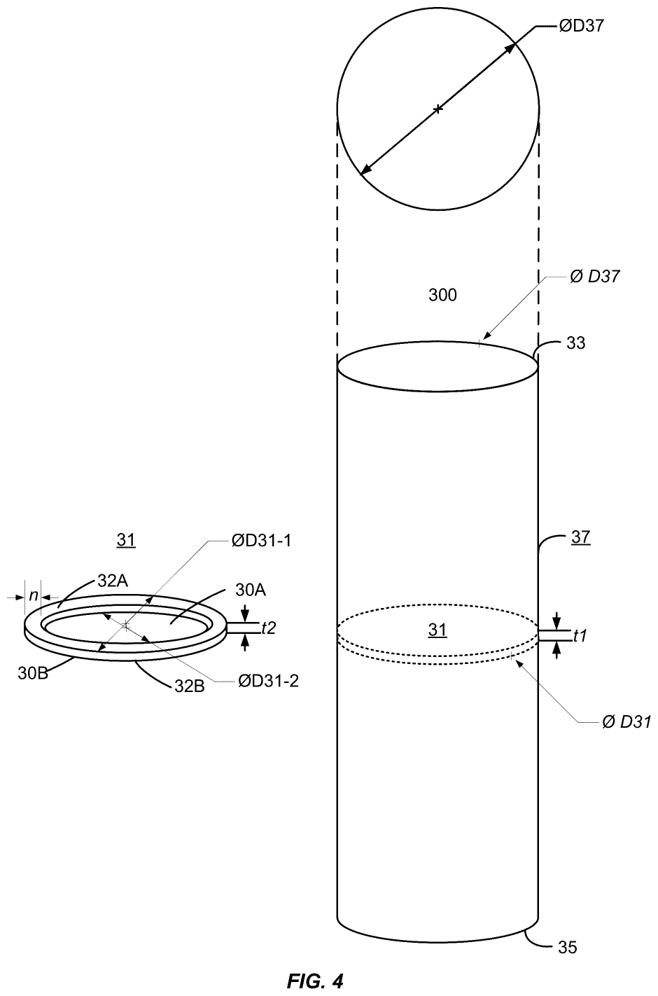

FIG. 4 is an elevation view of yet another example of a multi-compartment container according to at least one example. Multi-compartment container 300 can include a cylinder 37 having a first end 33 and a second end 35. A multi-compartment container 300 can also include a dividing wall 31. Cylinder 37 can have a diameter D37 dimensioned so that dividing wall 31, having a diameter D31, can slip or snugly fit within the inner diameter of cylinder 37. Dividing wall 31 can be coupled to the inner surface of cylinder 37 by any suitable means including, but not limited to, adhesive, welding, tacks and retaining rings or cylinders.

Dividing wall 31 can be made of any suitable material including, but not limited to, metal, plastic, cardboard, paper board, Mylar, foil or any combination or composite thereof. As shown in FIG. 4, dividing wall 31 can be a simple disk of some thickness t1 and diameter D31. Alternatively, dividing wall 31 can have structural or reinforcement lip sections 32A and 32B similar to that of the connecting-divider shown in FIG. 3. To conserve material and/or increase the structural integrity of the dividing wall 31, the dividing wall 31 can have a solid inner section between the first side 30A and second side 30B having a thickness t1 smaller than the thickness t2 between a surface of lip section 32A and a surface of lip section 32B. The dimension n of the dividing wall 31 can be defined as the difference between diameters D31-1 and D31-2. The dimension n can vary according to the requirements of a multi-compartment container and the materials used to construct dividing wall 31.

In some examples, the cylinder 37 and the dividing wall 31 can be molded as a unitary body. For example, the cylinder 37 and dividing wall can be injection molded out of plastic or other moldable as a unitary body. In such examples, the walls of the containers can be made of the same material.

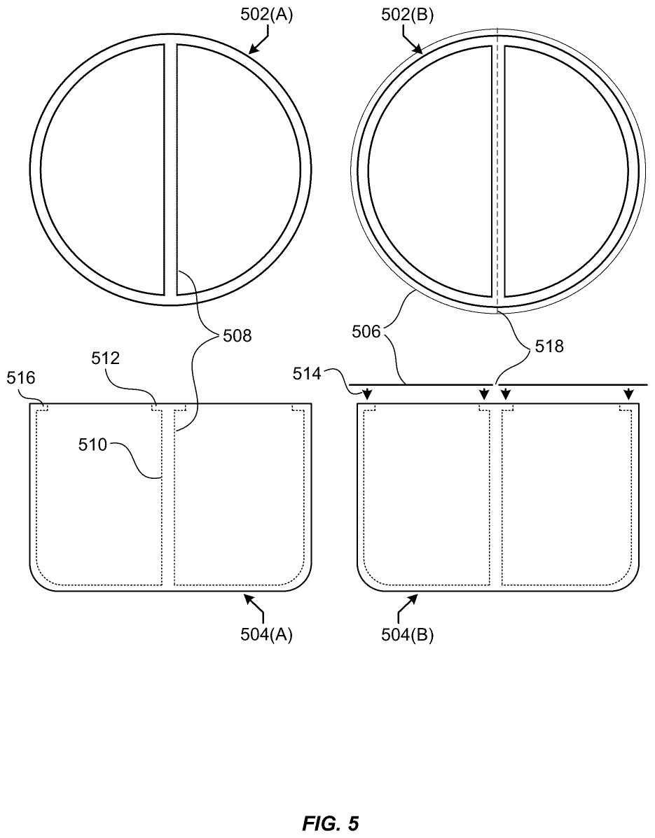

FIG. 5 is view of a multi-compartment container in which multiple compartments are divided via a divider wall in accordance with at least some examples. In some examples, each of the multiple compartments may be independently sealed so that accessing one of the compartments does not compromise the contents of the other compartment. FIG. 5 depicts top-down views 502 (A and B) of the multi-compartment container, as well as side views 504 (A and B) of the multi-compartment container. In FIG. 5, views 502(A) and 504(A) depict the multi-compartment container without seal 506 whereas views 502(B) and 504(B) depict the multi-compartment container with seal 506. In some examples, the outer walls of the multi-compartment container may be parallel. For example, the multi-compartment container may be cylindrical. In some examples, the outer walls of the multi-compartment container may be slanted. For example, the multi-compartment container may be conical. Although shown having a circular cross section, other cross sectional shapes such as an ellipse, square, or other shape may be envisioned.

As depicted in FIG. 5, multiple compartments may be formed in the multi-compartment container via the inclusion of a divider wall 508. The divider wall 508 may be a vertical divider. As depicted, divider wall 508 may be in contact with the outer wall, bottom, and top of the multi-compartment container. In some examples, the divider wall 508 may include an inner portion 510 and a reinforcement lip 512, where the reinforcement lip 512 is thicker than the inner portion 510 and runs along an outer edge of the divider wall 508. The reinforcement lip 512 may be at an open end of the multi-compartment container, adjacent a seal position for enclosing a volume within the multi-compartment container.

In some examples, the multi-compartment container may be configured such that each compartment may be independently sealed. In some examples, a seal 506 may be adhered to the outer walls and divider wall 508 of the multi-compartment container via contact points represented as arrows 514. In some examples, the outer wall may include a lip 516 which provides surface area for a contact point 514 at which the seal 506 may be adhered to the outer wall. Likewise, the reinforcement lip 512 may provide surface area for a contact point 514 at which the seal 506 may be adhered to the divider wall 508. In some examples, the outer wall may have a sloped or slanted side or may be vertical as shown.

Seal 506 may be made of any suitable flexible material capable of preventing the passage of air or liquid into a compartment of the multi-compartment container. For example, the seal 506 may be a thin layer of plastic. In some examples, seal 506 may include a perforation 518 at which the seal 506 may be separated. The perforation 518 may extend along a length of the divider wall 508. For example, the seal 506 may be a single plastic sheet which is adhered to each of the outer walls (via lip 516) and the divider wall (via reinforcement lip 512) and which is perforated along the divider wall 508. In these examples, the seal 506 may be broken at the perforations such that removing the seal 506 from a first compartment will not remove the seal 506 from the second compartment.

In examples that include perforation 518, the perforation 518 may be added to the seal 506 before or after the seal 506 is adhered to the multi-compartment container. In some examples, the perforation 518 may be formed in films and form a film perforation. In some examples, a single reusable closure element (e.g., a plastic snap-type lid) may be fitted over the outer walls of the multi-compartment container such that air exposure to the multiple compartments is restricted by the plastic lid. In some examples, the seal 506 may cover a single compartment of the multi-compartment container such that a first compartment remains sealed via the seal 506 and a second compartment is sealed using a lid. In some examples, the seal 506 may include two or more seals rather than a single seal having perforations.

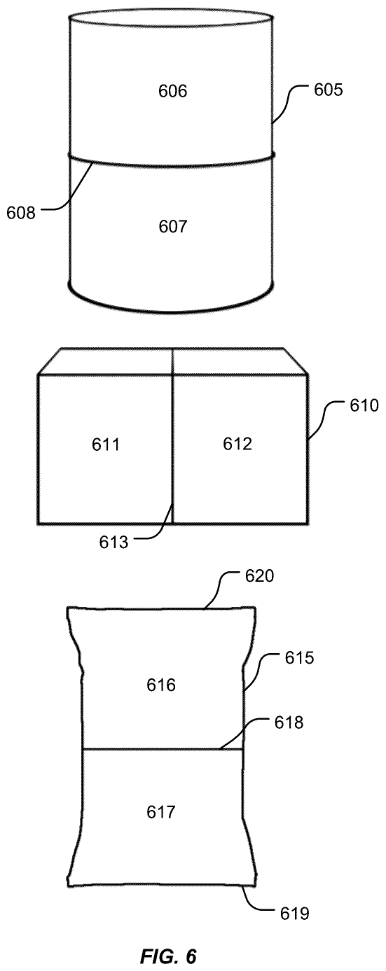

FIG. 6 shows various examples of a multi-compartment, including an example can or canister container, box and bag or sack in accordance with at least some examples. The illustrations of multi-compartment canister container 605, multi-compartment box 610 and multi-compartment bag 615 show the improvements according to various examples described herein. Each of the varieties of multi-compartment container, shown in FIG. 6 can be made of various materials and include various seals and lids based on the type of product that they will be used to package. Furthermore, even though the examples shown FIG. 6 each have two compartments, various examples can include more than two compartments.

Canister 605 may include two compartments 606 and 607. Compartment 606 and 607, as well as other compartments in other examples, may be separately manufactured and then attached to one another. In such examples, each compartment can be a full or partial container with or without a full set of side/walls, top and bottom. Such examples are described in more detail in related U.S. Pat. No. 7,571,829, and U.S. patent application Ser. No. 12/622,853. Alternatively, compartments 606 and 607 of canister container 605 may be made of a single cylindrical or other shape outer body with an interior divider wall 608.

The divider wall 608 may be oriented in any plane within canister container 605. In yet other examples, canister container 605 can include more than two compartments. In some examples, the divider wall 608 can be affixed to the interior wall of a cylinder, while in other examples the divider wall 608 can be included in the exterior structure of the canister container 605. In such examples, the divider wall 608 can be used to connect two cylinders of similar or dissimilar materials having either the same or different volumes.

Similarly, the divider wall 608 can have any shape to accommodate various products or divide up the volume of the multi-compartment container into structurally or visually interesting or aesthetic volumes. For example, divider wall 608 need not be a flat disc. In fact, for the purposes of reducing the material needed to manufacture the divider wall 608, divider wall can include stamped or molded ribs to increase the structural integrity. Also, it is possible that the divider wall can be in the shape of a cone, a parabolic rotation, or bubble shape with at least one plane, edge or rim that can connect to the wall of canister container 605. Such configurations can provide novel ways to divide the interior volumes of the multi-compartment container. Such examples can be particularly desirable for multi-compartment containers with transparent or translucent side walls, such that the divider and the separate volumes within the multi-compartment container can be seen or observed from the exterior of the multi-compartment container.

According to various examples, box 610 can include at least two compartments, such as 611 and 612. Box 610 can also include more than two compartments. Box 610 can be made of various materials. For example, the walls, sides, top and bottom of box 610 can include cardboard, paperboard, metal, wood, plastic, foil, Mylar™ or some composite or combination of the foregoing materials. Any material suitable for making walls, sides, top and bottom rigid enough to contain the intended contents of box 610 can be used.

Compartment 611 and 612 can be constructed of the same or different materials. In some examples, box 610 having compartments 611 and 612, can be constructed of a single piece of cardboard, paper or paperboard, or plastic using known box folding pattern and construction techniques. In other examples, box 610 can be constructed by joining two separate boxes having compartments 611 and 612 respectively. In other examples, box 610 can include a divider 613 affixed to the interior of box 610. The dividing wall 613 can define compartment 611 and 612 with identical or different volumes. According to other examples, box 610 can have more than two compartments. The divider wall 613 can be oriented in any plane within box 610, including planes parallel or perpendicular to the long or short axes of the box 610. Divider wall 613, can also have any shape suitable for separating the volumes of compartment 611 and 612.

In various examples, compartments 611 and 612 can be used to package the same or different products, materials or food stuffs. Each compartment 611 and 612 can be opened, unsealed or accessed individually. In such examples, while the contents of one compartment are in the process of being used or consumed, the contents of the other compartment remain sealed to protect freshness or potency. Such configurations have the advantage of providing larger quantities of the product to be packaged and sold with less potential of the contents losing freshness or potency due to exposure to air. From a consumer point of view, economical quantities of products can be purchased with a lower chance that the purchased product be lost to waste. These advantages provide potential for greater profitability on the side of the manufacturer or packager by creating a more desirable packaged product and thus higher demand, at the same time as providing potential cost savings of bulk quantity purchases for the user or consumer. As used herein, the terms consumer can include any type of entity, including, but not limited to, individuals, families, restaurant, food preparation professional, chefs, workers, hospitals, hotels, etc.

Also shown in FIG. 6 is bag 615. As shown, bag 615 can have two compartments 616 and 617. In some examples, compartments 616 and 617 can be formed by crimping, sewing or heat welding the non-rigid or semi-rigid walls of bag 615 at seam 618. The non-rigid or semi-rigid walls of bag 615 can include paper, plastic film, foil, Mylar™, cellulose or some combination or composite thereof. Bag 615 can have its top and bottom end seams 619 and 620 sealed in the same manner. In other examples, seam 618 can be oriented in the longitudinal direction running from end 619 to 620. In yet other examples, ends 619 and 620 can include re-closable seams or seals, such as zipper-type or reusable adhesive-type closures.

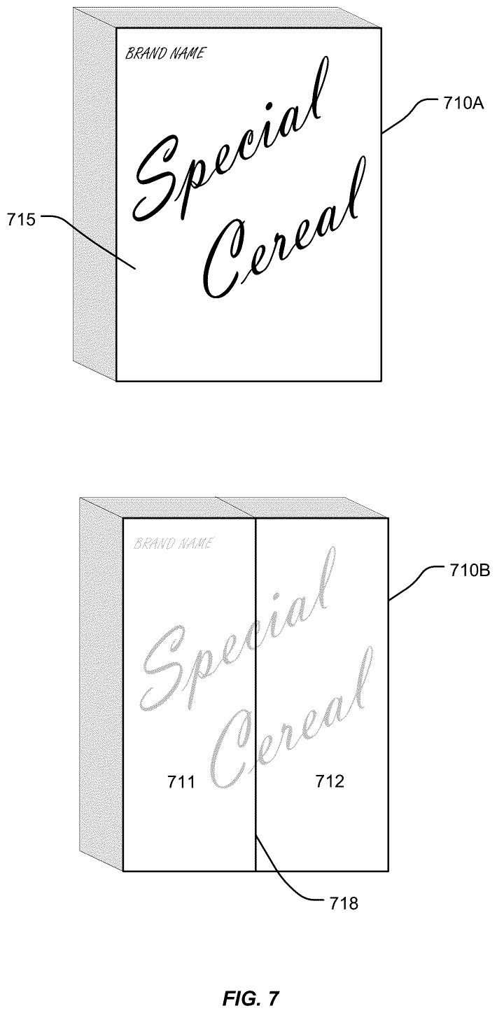

FIG. 7 shows an example of a two compartments cereal box 710A according to one example. Cereal box 710A can include compartments 711 and 712. The construction of cereal box 710A can include the same materials as described above in reference to box 610. Compartments 711 and 712 can be constructed of or include the same or different materials.

In various examples, a consumer can access and use the contents of compartment 711 without exposing the contents of compartment 712. Once the contents of compartment 711 are depleted, a user can open or unseal compartment 712 to access the contents of that compartment. Each of compartment 711 and 712 can include desiccants. Compartments 711 and 712 can also include liners, or re-sealable or reusable lids or closures elements for creating an airtight or hermetic enclosure, separate from the airtight or hermetic enclosure of the other compartment of the multi-compartment container.

Although cereal box 710A is shown and described as a cereal box, this example is only illustrative and should not be construed as limiting a box such as 710A to being only used for packaging cereal. Cereal box 710A, as well as any other container according to other examples, can be used to package numerous types of dry food, commercial or industrial products that are sensitive to air, such as grains, chips, marshmallows, pretzels, nuts, dried fruit, oats, weight control supplements, protein powders, milk additives, such as chocolate milk powder, plaster of Paris, baby food, cookies, crackers, baking mixes, pancake mixes, cake mixes, brownie mixes, drink mixes, car wax, greases, sealants, epoxies, glues, cigars, cigarettes etc.

As shown, the cereal box 710A can have an exterior surface 715. Exterior surface 715 can include a material identical to that of cereal box 710A or comprise a wrapper made of a different material. For example, the body of cereal box 710A can be made of cardboard or a composite of cardboard and plastic, while the exterior surface 715 can be or wrap made of plastic film or a separate piece of paper wrapped around or otherwise affixed to cereal box 710A. In some examples, it is desirable for the exterior 715 to have printed information to identify the contents and the proper use of the contents of cereal box 710A and its constituent compartments 711 and 712.

Box 710B shows the interior construction of cereal box 710A. As shown, box 710B includes a divider 718 separating compartments 711 and 712. Divider 718 can be oriented in any direction, including, but not limited to, vertical or horizontal with respect to the orientation of packaging. Divider 718 can be integral to the construction of the box 710B or can be a separate piece and even be made of a different material than the exterior 715, walls, sides, top and bottom of box 710B. In some examples, it is beneficial for the material of box 710B to include a composite material to further insure freshness and potency of the contents of compartments 711 and 712. To that end, it is often desirable to use a cardboard or paperboard laminated or other combined with plastic or Mylar™ type product in the construction of box 710B.

Various other boxes and containers according to various examples can be made of waterproof or moisture resistant materials such as plastic. Such examples are particularly advantageous when the contents of multiple compartments of the containers described herein are wet or moist. For example, such multi-compartment containers are useful for dispensing one portion of pre-moistened wipes from a tub, canister, bag, or other such container while keeping another portion fresh for future use. Such wipes can include fabric or paper based towels pre-moistened or laced with solutions, detergents, and medications for personal care and hygiene or household or industrial use. Some examples include wipes, moistened disinfectants, cleaners, polishes, waxes, soaps, or medications and topical solutions such as make-up removers, skin treatments, moisturizers and sanitary solutions.

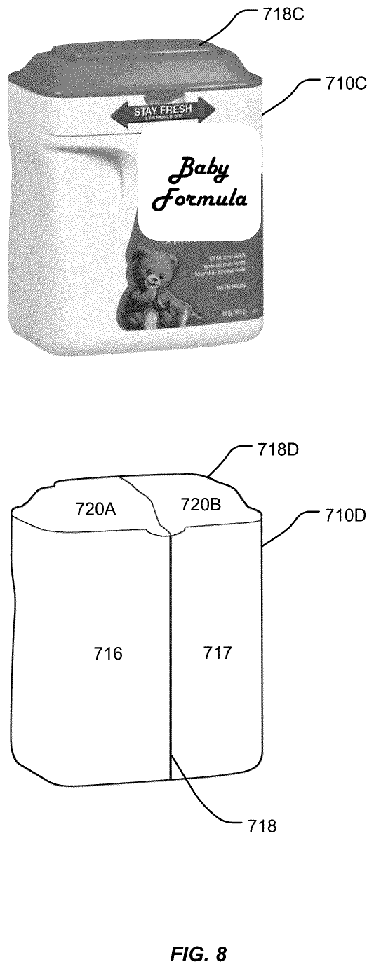

FIG. 8 shows one example of a plastic box 710C according to one example that can be suitable for packaging dry or wet products. As with the container shown in FIG. 7, the divider wall 718 in FIG. 8 can also be disposed in any orientation with respect to the other surfaces of the container.

By using an appropriate plastic or other polymer, box 710C can be used to package or contain various types of liquids and wet products that require special handling or an airtight seal to maintain usefulness. The airtight seal afforded by using a plastic material for the body and lid 718C for box 710C can be useful in other applications as well. Plastic materials are useful for making reusable and re-sealable or reusable lids or closure elements such as lid 718C. Such types of re-sealable lids or closure elements are useful for products that are used frequently or when the container is required to withstand being transported after the container is opened. For example, box 710C can be used to package products such as wet or dry baby formula that must survive being carried in a carry bag with other supplies on a regular basis while protecting the baby formula from contamination and preventing the baby formula from spilling. Such containers are also useful for frequently used and moisture sensitive products such as powdered drink, iced-tea and chocolate milk mixes.

Box 710D shows the internal construction of box 710C. As shown, box 710D can include compartments 716 and 717 that can be individually sealed with re-sealable lids 720A and 720B that make up lid 718D. In some examples, lids 720A and 720B can be opened and closed as a single unit or operated independently as individual lids. Examples in which lid 718D operates as a single piece, compartments 716 and 717 can be sealed by an additional and separately openable seals, such as one time use foil or plastic seals applied at the packaging facility. In other examples, lids 720A and 720B can be operated independently of one another and perform as the factory seal and the re-sealable lid for compartments 716 and 717 respectively.

In some examples, box 710C and 710D can be molded as a single piece or can include multiple separately molded pieces that can be adhered, welded or otherwise affixed to another to form multi-compartment boxes. In some examples, it may be desirable for box 710C and box 710D to include pour spouts or anti-drip spouts to prevent spills or protect the outside of the box from being contaminated or stained by the contents contained in compartments 716 and 717. Although only two compartments are described in reference to the boxes 710C and 710D are shown in FIG. 8, various other examples contemplate more than two compartments.

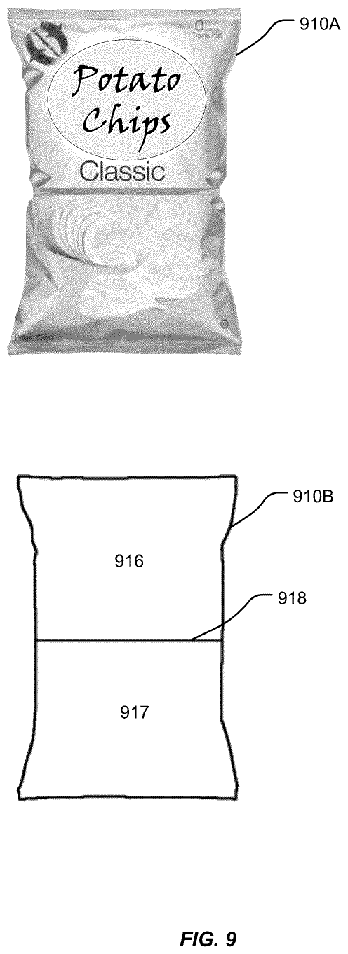

FIG. 9 shows a multi-compartment bag according to another example. Bag 910A can have sides or walls made of any suitable non-rigid material, pliable material, or semi-rigid material for containing and maintaining freshness of the intended contents. For example, the material of the non-rigid or semi-rigid walls of bag 910A can be plastic, plastic film, Mylar, paper or biodegradable or compostable cellulose or combination thereof. The material of the walls or sides of bag 910A can include any type of flexible, non-rigid or semi-rigid material. Bag 910B shows the internal construction of bag 910A.

As shown, bag 910B can include compartments 916 and 917 divided by dividing seam 918. As in other examples, compartments 916 and 917 can be used to contain or package the same or different materials from one another. Seam 918 can be formed in bag 910B to define separate compartments 916 and 917. As such, bag 910B can include compartments 916 and 917 as two separately openable pouches each having a separate portion of product therein. Seam 918 can be formed by crimping, sewing, welding or adhering the walls of bag 910B to one another to form two compartments 916 and 917. In some examples, seam 918 can include perforations that can be used to detach one of the compartments from the other compartments once the contents of the compartment are depleted. In such examples, the multi-compartment bag 910B can be reduced in size as the contents are used to save storage space and for the convenience of the user.

User or consumers can open and access the contents of each compartment or pouch individually, while maintaining the freshness of the contents of the other pouch until the contents of the first pouch are depleted.

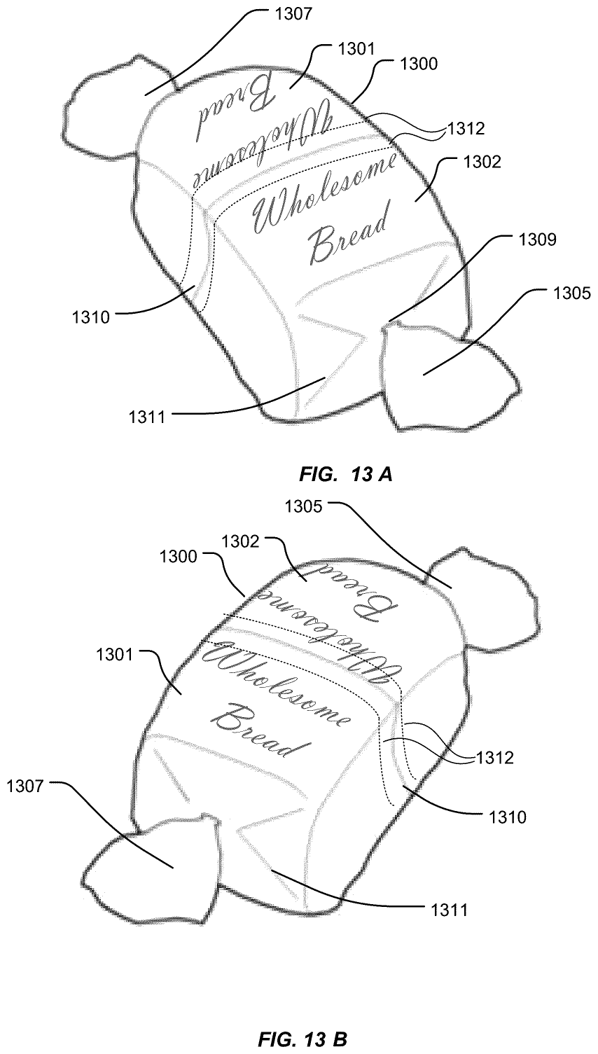

Bags 910A and 910B can be used to package various types of materials, products and foodstuffs. For example, bag 910A can be used to package foods such as potato chips, pretzels, nuts, hot dogs, salad and other foods that are susceptible to spoilage or staleness upon exposure to oxygen and moisture. In related examples, each compartment of a multi-compartment bag can contain a full or partial loaf of sliced or unsliced bread. Examples are described in greater detail elsewhere with respect to FIG. 13.

Alternatively, bag 910A can be used to package refill portions of regularly used household goods such as dish, laundry and hand soap, as well as condiments such as ketchup mustard or mayonnaise. In such examples, the use of a bag 910A can help reduce the amount of packaging required for distributing regularly used household goods while also providing users and consumers with an economical quantity discount.

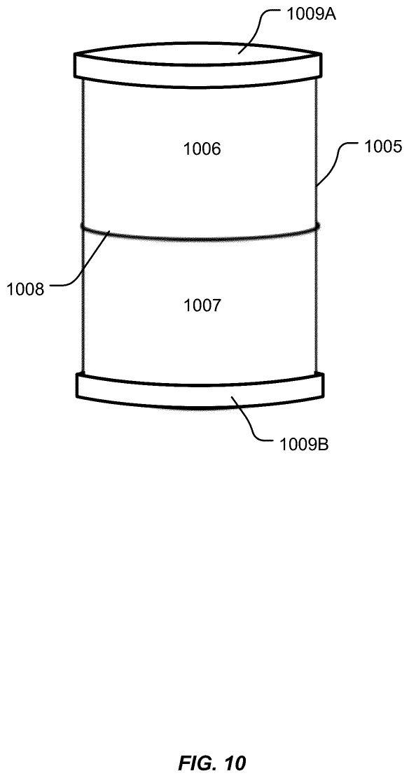

FIG. 10 shows another example that can include a multi-compartment container 1005 for packaging ice cream, though may be used to package other types of products. In such examples, multi-compartment container 1005 can include compartments 1006 and 1007 that can contain a portion of ice cream. Each compartment 1006 and 1007 separate from one another by divider 1008, as described above in references to FIG. 6. Each compartment 1006 and 1007 can also be sealed with a plastic film, foil or Mylar™ single use cover and also include a reusable lid 1009A or 1009B respectively. The single use seals allows a consumer to open only one portion of ice cream contained in multi-compartment container 1005, thus protecting the unopened portion from freezer burn or the formation of ice crystals that can develop despite the use of the reusable lids 1009A and 1009B, and thus prevent the degradation of the flavor and texture of ice cream.

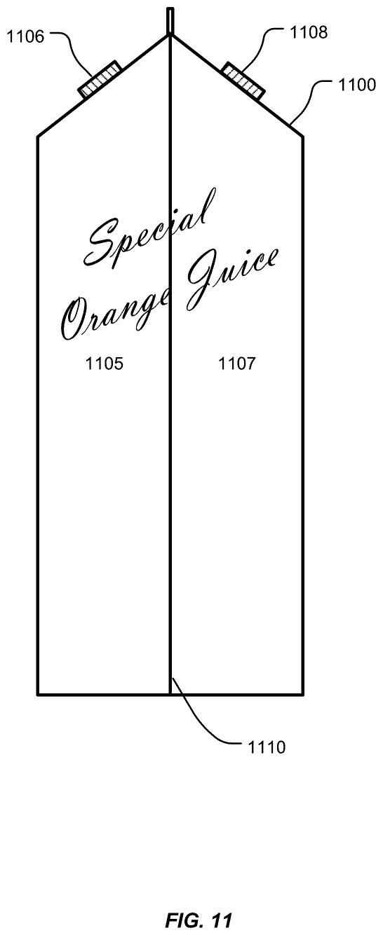

FIG. 11 show another example of a multi-compartment container. In this example, multi-compartment container can include a composite container for beverages or other liquids, such as dairy products like milk, cream, half and half, and buttermilk, as well as fruit and vegetable juices, soy milk, almond milks, peanut milk and other specialty beverages. Such multi-compartment containers can include at least two compartments 1105 and 1107 separated by divider 1110 that can have screw top caps like lids 1106 and 1108 respectively. Multi-compartment container 1100 can include an integrated construction, or can include two separated formed containers that are joined together along divider 1110. Multi-compartment container 1100 can include any of the aforementioned materials suitable for containing liquids.

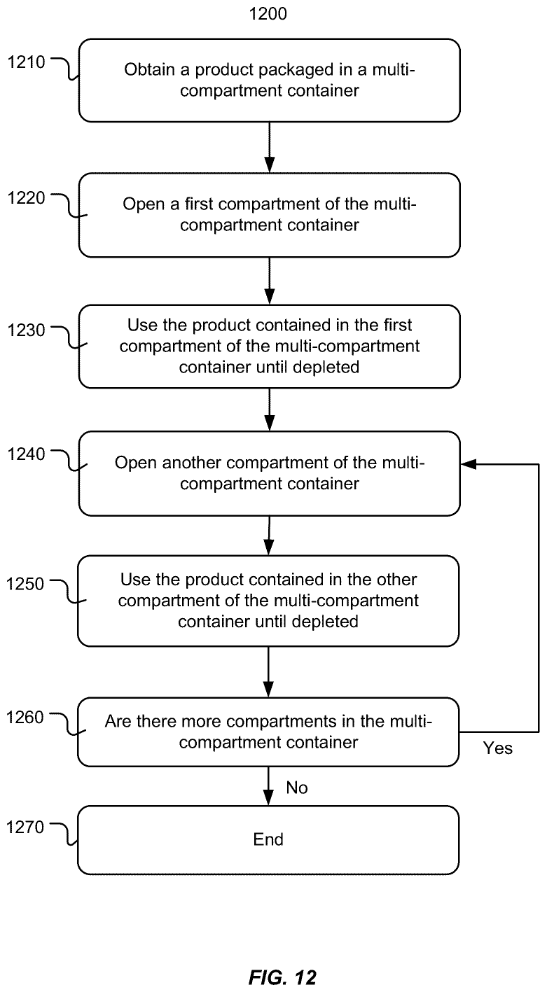

FIG. 12 is a flowchart of a method 1200 for using a multi-compartment container according to various examples. At step 1210, the consumer can obtain a product packaged in a multi-compartment container. In some examples, obtaining a packaged product having a multi-compartment container includes buying a product at a store or ordering a product online, while in other examples, the user can reuse a multi-compartment container refilled with the contents of his or her choice. A multi-compartment container can be used for home canning purposes.

At step 1220, a user can open one of the compartments of the multi-compartment container as described in reference to the figures above. The contents of the first compartment of the multi-compartment container can be used either all at once or incrementally, as the contents of the multi-compartment container are needed. If the contents of the multi-compartment container are being used incrementally, the time required to complete the contents of the first compartment may be such that if the entirety of the contents of the container were exposed to air and moisture, the quality, freshness or potency of the contents might be compromised if it were not sealed in the second compartment.

In step 1230, a user can use the product contained in the first compartment of the multi-compartment container until it is depleted. At this point the user can open a second compartment of the multi-compartment container at step 1240. The contents of the second compartment of the multi-compartment container can then be used until it is depleted in step 1250. Once the product contained in the second compartment of the multi-compartment container is depleted, the user can then use any other available compartments of the multi-compartment container still containing product. This is the case if the multi-compartment container includes more than two separate compartments.

At step 1260, if there is yet another compartment of the multi-compartment container that still contains product, the user can repeat steps 1240 through 1260 until no product remains in any compartments of the multi-compartment container. Once all contents of the multi-compartment container are depleted, the user can discard, reuse or recycle the multi-compartment container in step 1270.

FIGS. 13A and 13B depicts an illustrative example of a multi-compartment container (in this case a bag) used for packaging bread in accordance with at least some examples. FIG. 13A depicts the multi-compartment container 1300 from a first angle and FIG. 13B depicts the multi-compartment container from a second angle. In examples directed toward packaging bread shown in FIGS. 13A and 13B, the divider 1310 that separates compartments 1301 and 1302 of multi-compartment container 1300 may be a sheet of similar or dissimilar material as the walls of the multi-compartment bag to provide a less constricting volume within each compartment. Such dividers may be constructed according to various methods of attaching and pleating the bag material. The divider may be formed as the bag is opened, for example with the divider integral with outer wall and formed as the bag is opened to load with contents. The pleats of divider 1310 can be similar to pleats 1311. The openable portions 1305 and 1307 of the multi-compartment container 1300 may include various closure systems to help preserve the freshness of the contents. Such closures can include twist ties 1309, clips, and zip type seals.

In some examples, the multi-compartment container 1300 may include a number of perforations 1312 that can be used to separate compartments 1301 and 1302 for example to tear off excess packaging after a compartment has been used. For example, the outer material of the multi-compartment container 1300 may be separated from the multi-compartment container 1300 at a first perforation 1312 upon depleting the contents of a first compartment. Alternatively, the outer material of the multi-compartment container 1300 may be separated from the multi-compartment container 1300 at a second perforation 1312 upon depleting the contents of a second compartment. It should be noted that the compartments 1301 and 1302 of the multi-compartment container 1300 may be depleted in any order. In some examples, the perforations 1312 may be some predetermined distance from the divider wall 1310 on the outer surface of the multi-compartment container 1300. In some examples, the multi-compartment container 1300 may include a single perforation 1312.

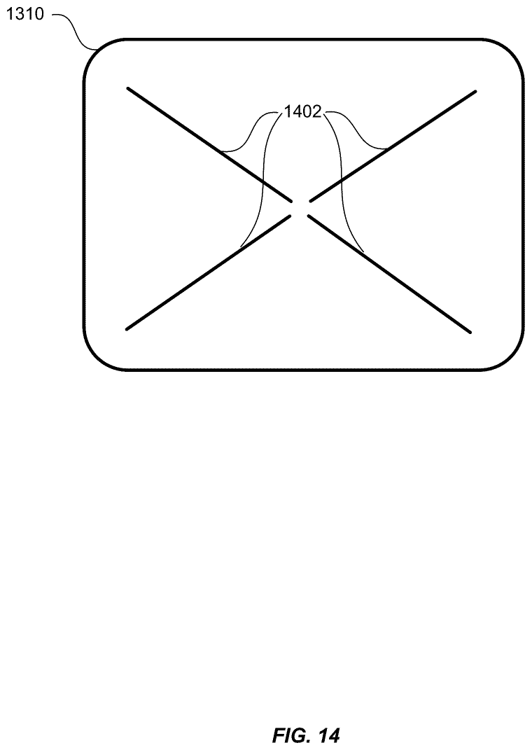

FIG. 14 depicts an illustrative example of a divider wall for a multi-compartment container. More particularly, the divider wall 1310 may be an example of divider wall 1310 described in relation to FIG. 13 above. As discussed in FIG. 13 above, the divider wall 1310 may include a number of pleats 1402. The pleats 1402 may be similar to pleats 1311. For example, pleats 1402 may be made in the same position and style as pleats 1311.

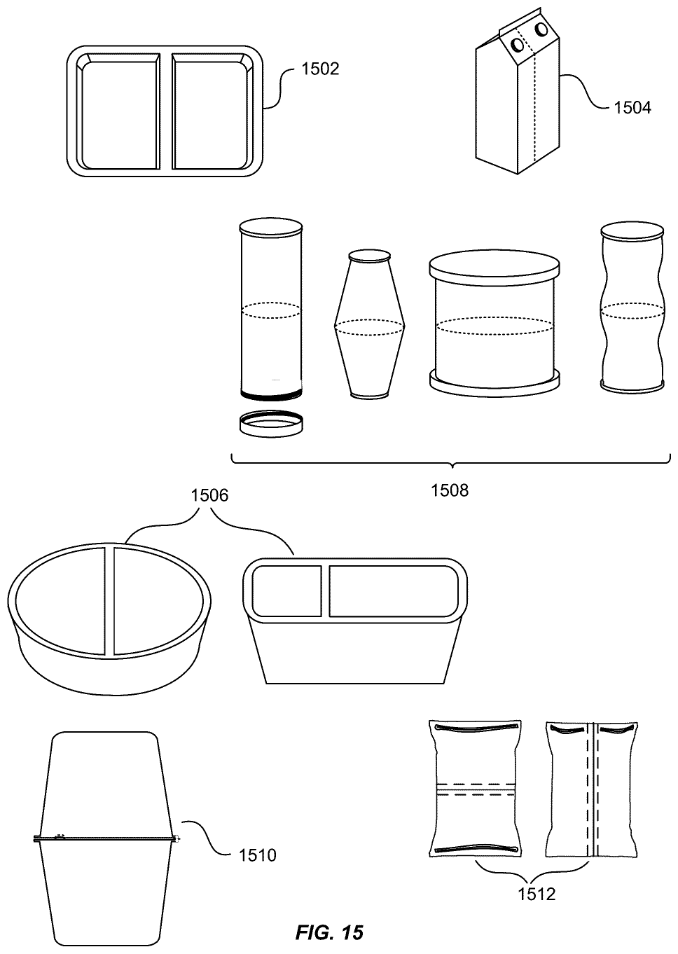

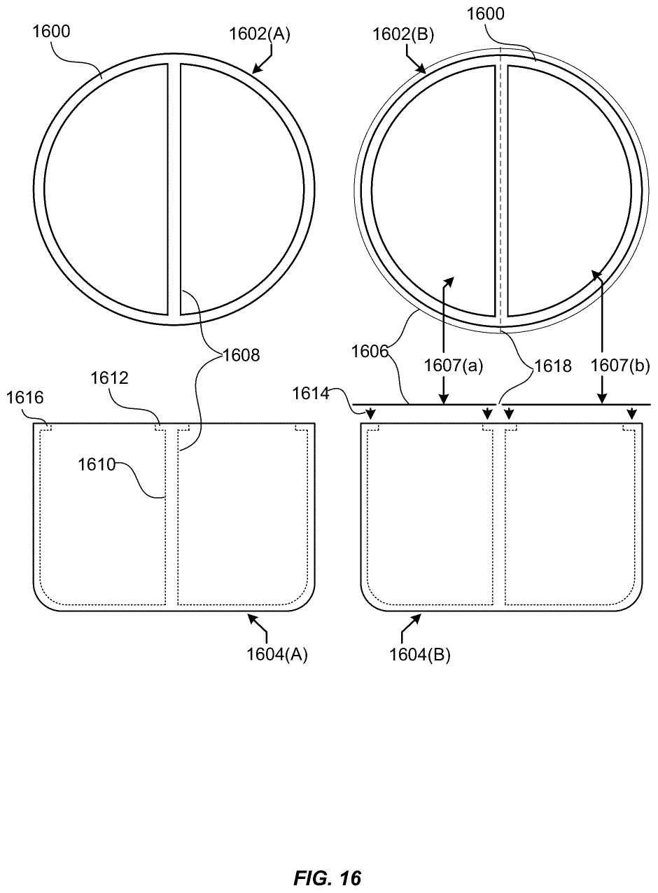

FIG. 15 depicts various examples of multi-compartment containers, including a tray 1502, a carton container 1504, tubs 1506, a number of canister containers 1508, clamshell packaging 1510, and bags 1512 that are discussed individually in FIGS. 16-24. The illustrations of the various multi-compartment containers 1502-1512 demonstrate a number of advantages over conventional packaging as will be described herein. Each of the varieties of multi-compartment container, shown in FIG. 15 can be made of various materials and include various seals and lids based on the type of product that they will be used to package. Furthermore, even though the examples shown FIG. 15 each have two compartments, various examples can include more than two compartments.

In some examples, the multi-compartment container may be constructed of the same or different materials. In some examples, the multi-compartment container having multiple compartments, can be constructed of a single piece of cardboard, paper or paperboard, or plastic using known box folding pattern and construction techniques. In other examples, the multi-compartment container can be constructed by joining two separate containers having respective compartments. In other examples, the multi-compartment container can include a divider wall affixed to the interior of the multi-compartment container. The divider wall can define the separate compartments with identical or different volumes. According to other examples, the multi-compartment container can have more than two compartments. The divider wall can be oriented in any plane within the multi-compartment container, including planes parallel or perpendicular to the long or short axes of the multi-compartment container. The divider wall may be parallel or perpendicular to seams that provide access to the internal portions of compartments, such as perpendicular to a first and a second seam. The divider wall, can also have any shape suitable for separating the volumes of the multiple compartments of the multi-compartment container. The divider wall can be integrally formed with side walls or may be inserted after forming other portions of the containers.

The divider wall can have any shape to accommodate various products or the divide up the volume of the multi-compartment container into structurally or visually interesting or aesthetic volumes. Different configurations can provide novel ways to divide the interior volumes of the multi-compartment container. Such examples can be particularly desirable for multi-compartment containers with transparent or translucent side walls, such that the divider and the separate volumes within the multi-compartment container can be seen or observed from the exterior of the multi-compartment container.

Each of the multi-compartment containers 1502-1512 can be made of various materials. For example, the walls, sides, top, bottom, or any other portion of the multi-compartment container can include cardboard, Styrofoam, paperboard, metal, wood, plastic, foil, Mylar™ or some composite or combination of the foregoing materials. Any material suitable for making the structural features (e.g., walls, sides, top and bottom) rigid enough to contain the intended contents of the multi-compartment container can be used.

The multiple compartments of the multi-compartment container can be used to package the same or different products, materials or food stuffs. Each compartment can be opened, unsealed or accessed individually. In such examples, while the contents of one compartment are in the process of being used or consumed, the contents of the other compartment remain sealed to protect freshness or potency. Such configurations have the advantage of providing larger quantities of the product to be packaged and sold with less potential of the contents losing freshness or potency due to exposure to air. From a consumer point of view, economical quantities of products can be purchased with a lower chance that the purchased product be lost to waste. These advantages provide potential for greater profitability on the side of the manufacturer or packager by creating a more desirable packaged product and thus higher demand, at the same time as providing potential cost savings of bulk quantity purchases for the user or consumer. As used herein, the terms consumer can include any type of entity, including, but not limited to, individuals, families, restaurant, food preparation professional, chefs, workers, hospitals, hotels, etc.

When one desires access to a product, one simply opens one compartment of the container. Thus, the second compartment remains unopened, thereby protecting the product therein from the elements and helping maintain freshness. When access to the second compartment is desired, the multi-unit storage device is “flipped” and the second compartment is opened. Each compartment may be closed with lids if provided. One lid may be provided and used for both containers if desired.

Additionally, each compartment may be filled with a different product if it is so desired. For example, one compartment may include potato chips while the second container may include corn chips. Each compartment may, in some examples, be designed to hold different types of food products. For example, the canister containers 1508 may include a first side for holding snacks with a snap on lid while a second side is for holding liquids, with a screw on lid. In a further example, the canister containers 1508 may include a first insulated side having insulated walls, such as for containing and maintaining hot or cold items while the second side may be uninsulated. In some examples, both sides may be insulated. In some examples the sides of the containers 1508 may be tapered, sloped, curved, straight, or otherwise shaped.

The multi-compartment containers described herein provide additional benefits beyond freshness, portioning of food, and convenience. In some examples, such as with bags 1512, sharing of the food product may be provided in a manner to prevent contamination, for example in case one or more people wish to share a food product but may be sick. In a particular example, the bags 1512 may include a food product such as chips that may be shared, with one or more people removing chips from the interior of the bag. With the multi-compartment containers, each person may have their own portion that is untouched by another person, thereby preventing any spreading of illness from person to person through the shared food item.

FIG. 16 depicts a view of a multi-compartment container 1600 in which multiple compartments are divided via a divider wall in accordance with at least some examples. The multi-compartment container 1600 shown in FIG. 16 may be an example of the tubs 1506 of FIG. 15. In some examples, each of the multiple compartments may be independently sealed so that accessing one of the compartments does not compromise the contents of the other compartment. FIG. 16 depicts top-down views 1602 (A and B) of the multi-compartment container 1600, as well as side views 1604 (A and B) of the multi-compartment container 1600. In FIG. 16, views 1602(A) and 1604(A) depict the multi-compartment container 1600 without seal 1606 whereas views 1602(B) and 1604(B) depict the multi-compartment container 1600 with seal 1606. In some examples, the outer walls of a container body of the multi-compartment container 1600 may be parallel. For example, the multi-compartment container 1600 may be cylindrical. In some examples, the outer walls of the multi-compartment container 1600 may be slanted. For example, the multi-compartment container 1600 may be conical.

As depicted in FIG. 16, multiple compartments may be formed in the multi-compartment container 1600 via the inclusion of a divider wall 1608. The divider wall 1608 may be a vertical divider. As depicted, divider wall 2168 may be in contact with the outer wall, bottom, and top of the multi-compartment container 1600. In some examples, the divider wall 1608 may include an inner portion 1610 and a reinforcement lip 1612, where the reinforcement lip 1612 is thicker than the inner portion 1610 and runs along an outer edge of the divider wall 1608. The divider wall 1608 may divide the multiple compartments into roughly equal volumes in some examples. In some examples, the divider wall 1608 may divide the multiple compartments into different volumes, for example with a first volume larger than a second volume.

In some examples, the multi-compartment container 1600 may be configured such that each compartment may be independently sealed such that each compartment may be independently accessible. In some examples, a seal 1606 may be adhered to the outer walls and divider wall 1608 of the multi-compartment container 1600 via contact points represented as arrows 1614. In some examples, the outer wall may include a lip 1616 which provides surface area for a contact point 1614 at which the seal 1606 may be adhered to the outer wall. Likewise, the reinforcement lip 1612 may provide surface area for a contact point 1614 at which the seal 1606 may be adhered to the divider wall 1608. The seal 1606 may couple to the reinforcement lip 1612. In some examples, seal 1606 may be a single sheet of plastic which may form multiple seals (e.g., a first seal 1607(a) and a second seal 1607(b)). The first seal 1607(a) and the second seal 1607(b) may each couple to the reinforcement lip 1612. In these examples, the single sheet of plastic may include perforations between the first seal 1607(a) and the second seal 1607(b) that can be used to detach the first seal from the first compartment without compromising the integrity of the second seal on the second compartment or disturbing the second seal. In some examples, the first seal 1607(a) or the second seal 1607(b) may be detached from the respective first and second compartments without breaking the other seal. In some examples, the first seal 1607(a) or the second seal 1607(b) may be detached from the respective first compartment or the second compartment without disturbing the second seal.

Seal 1606 may be made of any suitable flexible material capable of preventing the passage of air or liquid into a compartment of the multi-compartment container 1600. For example, the seal 1606 may be a thin layer of plastic. In some examples, seal 1606 may include a perforation 1618 at which the seal 1606 may be separated. For example, the seal 1606 may be a single plastic sheet which is adhered to each of the outer walls (via lip 1616) and the divider wall (via reinforcement lip 1612) and which is perforated along the divider wall 1608. In these examples, the seal 1606 may be broken at the perforations such that removing the seal 1606 from a first compartment will not remove the seal 1606 from the second compartment.

In examples that include perforation 1618, the perforation 1618 may be added to the seal 1606 before or after the seal 1606 is adhered to the multi-compartment container 1600. In some examples, a single reusable closure element (e.g., a plastic snap-type lid) may be fitted over the outer walls of the multi-compartment container 1600 such that air exposure to the multiple compartments is restricted by the plastic lid. In some examples, the seal 1606 may cover a single compartment of the multi-compartment container 1600 such that a first compartment remains sealed via the seal 1606 and a second compartment is sealed using a lid.

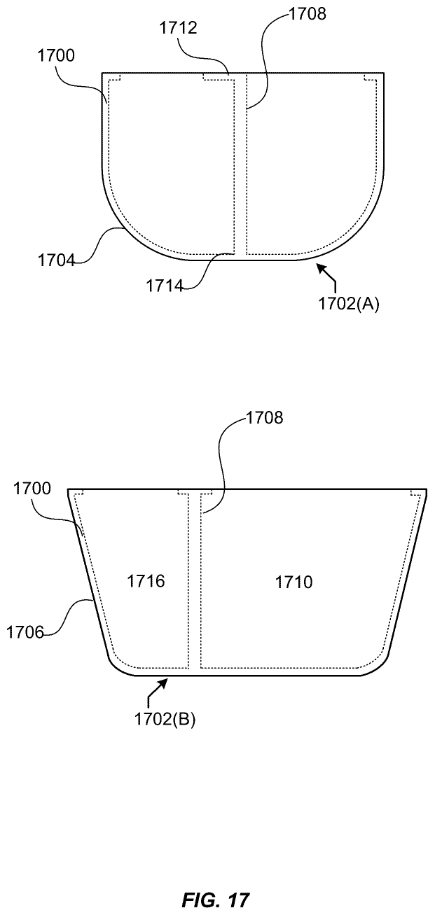

FIG. 17 depicts variations in design which can be implemented into the multi-compartment container 1600 of FIG. 16 above described in accordance with at least some examples. The multi-compartment container 1700 of FIG. 17 includes a divider wall 1708 similar to the divider wall 1608 and a reinforcement lip 1712 similar to the lip 1612 of FIG. 16. As depicted in 1702(A), the multi-compartment container 1700 may include exterior corners which are rounded or beveled as shown at 1704. Such a feature may advantageously enable some types of contents to be removed from a compartment of the multi-compartment container 1700 more efficiently. In some examples, interior corners, such as at 1712 may likewise be rounded to further enable some types of contents to be removed with ease.

Additionally, as depicted in 1702(A), a reinforcement lip 1712 may not be centered on the divider wall 1708. For example, the reinforcement lip 1712 may be skewed or biased to one side or the other, such that the reinforcement lip 1712 disproportionately covers a particular compartment or compartments as opposed to other compartments.

As depicted in 1702(B), the multi-compartment container 1700 may include sides 1706 which are sloped or straight (e.g., parallel sides). Note that sloped sides 1706 may also advantageously enable some types of contents to be removed from a compartment of the multi-compartment container 1700 more efficiently.

As also depicted in 1702(B), the divider wall 1708 may be positioned in any suitable manner. For example, the divider wall 1708 may be positioned off-center, such that a first compartment 1716 varies in size from a second compartment 1710. The divider wall 1708 also need not be in contact with the side walls of the multi-compartment container 1700. For example, the divider wall 1708 may run from a first corner of the multi-compartment container 1700 to a second corner to divide the multi-compartment container 1700 diagonally. Additionally, a divider wall 1708 may take any suitable shape. For example, the divider wall 1708 may be curved or otherwise non-linear.

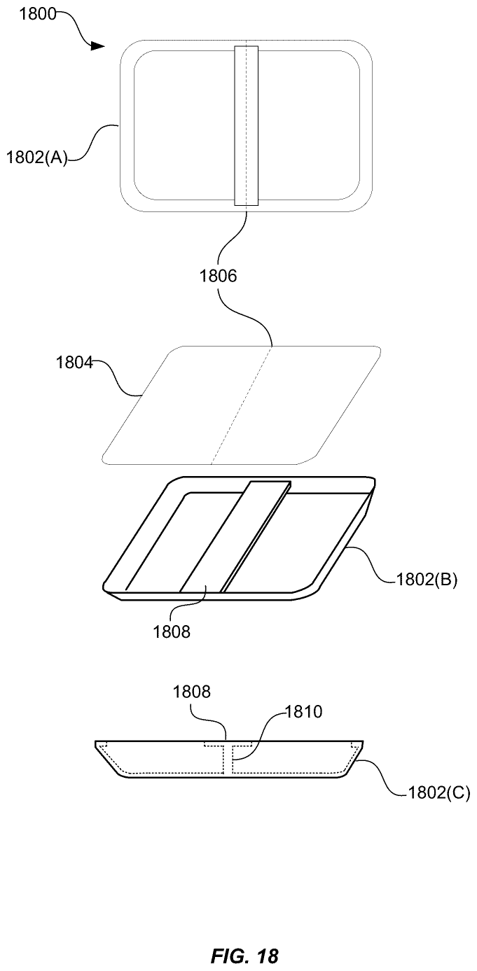

FIG. 18 depicts an illustrative example in which the multi-compartment container 1800 is a tray having a divider in accordance with examples. The multi-compartment container 1800 of FIG. 18 may be an example of the tray 1502 of FIG. 15. Numerous views of the multi-compartment container 1800 are presented. more particularly, FIG. 18 depicts a top-down view 1802(A) of the multi-compartment container 1800, as well as an expanded view 1802(B) of the multi-compartment container 1800, and a side view 1802(C) of the multi-compartment container 1800.

As shown in FIG. 18, the multi-compartment container 1800 may include a film 1804 (e.g., a plastic film) or other suitable means for sealing the compartments of the multi-compartment container 1800. the film 1804 may further include a perforation 1806, which divides the film. The placement of the perforation 1806 may correspond to the location of a reinforcement lip 1808 located on a divider wall 1810 of the multi-compartment container 1800. In some examples, the perforation 1806 may be added to the film 1804 after the film 1804 has been affixed to (e.g., sealed to) the multi-compartment container 1800. In some examples, the compartments, divider wall 1810, side walls, reinforcement lip 1808, and other features of the multi-compartment container 1800 of FIG. 18 may include one or more variations as described with respect to other examples herein, for example to include different positions of the divider wall 1810, curves and slopes on side walls, and other such variations as described herein.

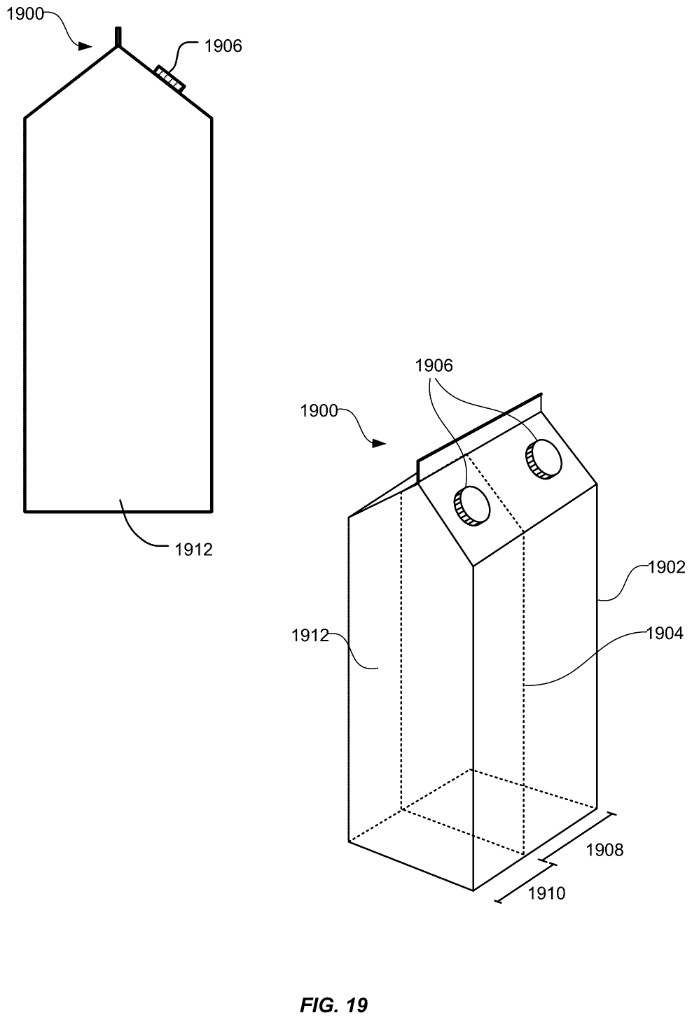

FIG. 19 depicts an illustrative example in which the multi-compartment container 1900 is a carton container having a divider in accordance with examples. The multi-compartment container 1900 of FIG. 19 may be an example of the carton container 1504 of FIG. 15. In this example, multi-compartment container 1900 can include a composite container for beverages or other liquids, such as dairy products like milk, cream, half and half, and buttermilk, as well as fruit and vegetable juices, soy milk, almond milks, peanut milk, and other specialty beverages. Such multi-compartment containers can include at least two compartments separated by divider 1904, and can have spouts 1906 through which contents are dispensed, which may be sealed using replaceable lids (e.g., screw top caps). A first spout 1906 is coupled to a first compartment 1902 while a second spout 1912 is coupled to a second compartment 1912. Multi-compartment container 1900 can include an integrated construction, or can include two separated or separable formed containers that are joined together along divider 1904. Multi-compartment container 1900 can be constructed of any materials suitable for the purposes of the multi-compartment container 1900 (e.g., containing liquids).

It should be noted that divider wall 1904 may be positioned within the multi-compartment container 1900 in such a way that the volume of the separate compartments is not equivalent. For example, the divider wall 1904 may be placed some distance 1908 away from one side of the multi-compartment container 1900 and some distance 1910 away from an opposite side of the multi-compartment container 1900. The divider wall 1904 results in a first compartment 1902 and a second compartment 1912 of the multi-compartment container 1900. The volume of the two resulting compartments 1902 and 1912 of the multi-compartment container 1900 would then vary based on each of the respective distances 1908 and 1910. The first compartment may enclose a first volume while the second compartment encloses a second volume, the first volume greater than the second volume. In some examples, this may enable the multi-compartment container 1900 to include different portions of different contents. For example, the multi-compartment container 1900 may include, in the first compartment 1902, a large portion of milk and, in the second compartment 1912, a smaller portion of cream. The first compartment 1902 encloses a first volume while the second compartment 1912 encloses a second volume. The first volume and second volume may be identical or may be different as described herein.

In some examples, the spouts 1906 may each be placed on the same side, e.g., on a single side, of the multi-compartment container 1900 (e.g., in the manner depicted in FIG. 19). If the multi-compartment container 1900 is being used to store multiple liquids, this may allow a user to pour a mix of those liquids which is proportionally appropriate without needing to measure the contents being poured. For example, if the multi-compartment container 1900 includes both milk and cream in the respective separate compartments, a user could remove each of the lids sealing the spouts 1906 and pour both the milk and cream at the same time, enabling the user to obtain half and half without the need for measurement. In this way, the multi-compartment container 1900 would enable a user to obtain milk, cream, or half and half from the same container depending upon the needs of the user. In some examples, one or more of the spouts 1906 may be configured to dispense the contents at a different rate than the other spout. The spouts 1906 may include different opening areas, such as different area through which liquid may exit the container. The opening area may be fixed or adjustable in some examples. For example, one spout may include a larger or smaller opening than the other spout. In a particular example, the first spout may have a first opening area through which a first liquid is dispensed while the second spout has a second opening area through which a second liquid is dispensed, the first opening area greater than the second opening area. This would enable a user to obtain, with a single pour, a mixture which is proportionally constant, such as at a fixed proportion or an adjustable proportion by opening or restricting a valve of the spouts 1906. Note that this could easily be expanded to more complex mixtures. For example, a multi-compartment container 1900 which includes vodka, coffee liqueur, and milk in three separate compartments (having two dividers) could be used to pour a White Russian which is proportionally appropriate in a single pour and without taking measurements.

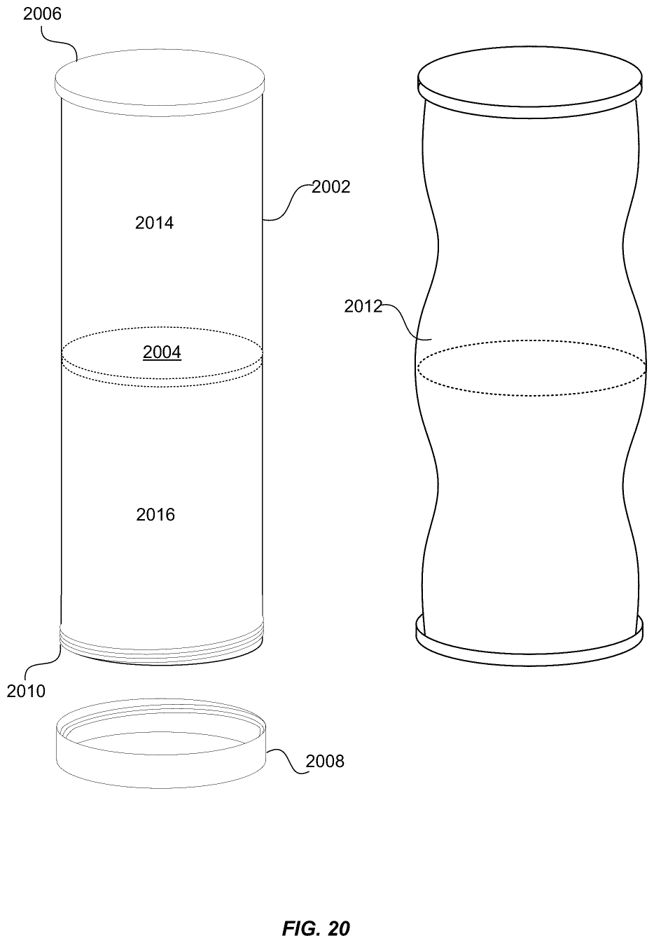

FIG. 20 depicts an illustrative example of multi-compartment containers 2002 and 2012 which may be referred to as canister containers, each having a divider in accordance with examples of the present disclosure. The multi-compartment containers 2002 and 2012 of FIG. 20 may be an example of the canister containers 1508 of FIG. 15. In some examples, the multi-compartment containers 2002 and 2012 consists of two containers 2014 and 2016 or cans which have been joined. For example, the containers 2014 and 2016 may be made of metal, in which case they may be welded together at their respective bottom portions (i.e., the portion opposite the opening). In some examples any other suitable material may be used. Glue or some other type of adhesive may also be used. Examples of separate containers that can be joined include coffee cans, nut cans, potato chip cans and other types of snacks. In some examples, a divider wall 2004 may be inserted into a compartment or tube in order to form the multi-compartment container 2002. The multi-compartment container 2002 may also be made as a unitary body of plastic or other suitable material. Examples of such a container include orange juice cans, nut cans, coffee, some potato snack cans and other snack cans.

The openings at either end of the multi-compartment container 2002 can be sealed with a film (e.g., metal, foil, plastic or any other suitable material). Additionally, one or more lids 2006 or 2008 can be provided for closing or resealing the multi-compartment container 2002. The lid 2006 may be a first seal coupled to the first compartment 2014 while the lid 2008 is a second seal coupled to the second compartment 2016. The first seal may be disposed on a first end of the multi-compartment container 2002 while the second seal may be disposed on a second end of the multi-compartment container 2002. Examples of suitable lids may include a snap-type sealable lid 2008 which is a flexible lid capable of being “snapped” over an opening of the multi-compartment container 2002 to form a seal, and may be referred to as a snap on lid. A second example of a suitable lid may include a screw type cap 2008 such as a threaded connection that is configured to seal an opening of the multi-compartment container 2002 when threaded onto corresponding threads 2010 of the opening. In some examples, a single lid may be provided which fits over both openings of the multi-compartment container 2002. For example, after removing the contents of one compartment of the multi-compartment container 2002, the user may remove a film sealing the second compartment of the multi-compartment container 2002 in order to remove the contents in that compartment. In this example, the user may use the same lid to reseal each of the first and second compartment of the multi-compartment container 2002.

In some examples, the first container 2014 and the second container 2016 may be identical to one another while in some examples the containers 2014 and 2016 may differ in one or more ways. As depicted in FIG. 20, the lids may be of a different style. The different style of lids may accommodate different food products, for example with solid food products in the first container 2014 and liquid food products in the second container 2016. In some examples, the first container 2014 may be a thin-walled container for maintaining food products at an ambient temperature while the second container 2016 may be insulated with insulated walls to maintain food products above or below an ambient temperature. In some examples, both of the first and second containers 2014 and 2016 may be insulated, configured to hold solid or liquid food products, or otherwise configured for storing various items.

As depicted by multi-compartment container 2012, the multi-compartment container 2002 need not include straight surfaces. For example, the outer walls of the multi-compartment container 2012 may be curved or indented. As would be appreciated by one skilled in the art, this would enable easier handling of the multi-compartment container 2012 by a user. In some examples, the walls may taper from each end to a wider middle portion, such that the container fits, in either orientation, in a cup holder.

In accordance with examples described herein, each compartment of the multi-compartment container 2002 may be filled with a product and then individually vacuum, nitrogen flush or otherwise sealed. This may be done before or after the two containers are coupled to one another. Each compartment may be filled with the same product or different products. Examples of products include, but are not limited to, coffee, nuts, potato chips, candy, tea, dried fruit, etc. In some examples, the two compartments may be suited to store different types of content. For example, a first compartment of the compartments may be suited to store liquid while a second compartment is suited or configured to store dry goods. This may enable the multi-compartment container 2002 to store a dry snack (such as nuts) as well as a beverage. Each of the first compartment and the second compartment may be independently accessible.

In various examples, the first compartment 2014 and the second compartment 2016 of the multi-compartment container 2002 include hollow compartments with a wall thickness, w, dimensioned to produce the structural rigidity suitable for containing and protecting products packaged therein, maintaining optional vacuum or pressure or stacking of multiple containers during shipping and display. Either compartment can include an interior surface and an exterior surface with similar or dissimilar materials. For example, the exterior surface can be coated in a plastic film while the interior surface can be coated with a metal foil. The wall thickness, w, can depend on multiple factors, such as the intended use of the multi-compartment container 2002, the material of the compartments and the intended packaging method. For example, the wall thickness, w, for a cardboard compartment can be thicker than that of a metal compartment, especially if the resulting multi-compartment container 2002 is intended to be vacuum, pressure or nitrogen flushed sealed. Nitrogen flush sealing replaces the air inside the container to remove oxygen and moisture to help better preserve the freshness of the packaged products.

When fully assembled, multi-compartment container 2002 can have one compartment, or container, with walls of uniform diameter defined by the inner surface of compartment 2014 and a bottom defined by a first side of the divider wall 2004 and another compartment, or container, with walls defined by the inner surface of compartment 2016 and the bottom defined by a second side of the divider wall 2004. In some examples, the first compartment 2014 and the second compartment 2016, each having some wall thickness w, may be coupled to the surfaces of opposite sides of the divider wall 2004. The divider wall may define the first compartment and the second compartment, wherein each of the first compartment and the second compartment are independently accessible.

In other examples, in which the walls are plastic or other material, the compartments can have non-uniform diameter from one end to the other or other arbitrary shape as determined by the aesthetics or design of the packaging. For example, the plastic walls can have depressions or impressions that make it easier to hold or handle the multi-compartment container, such as depicted with multi-compartment container 2012. Similarly, the compartments can any shape required by the product or the needs of the aesthetic design with two or more separately sealable/openable compartments, i.e. the shape of a cartoon character or trademark character.

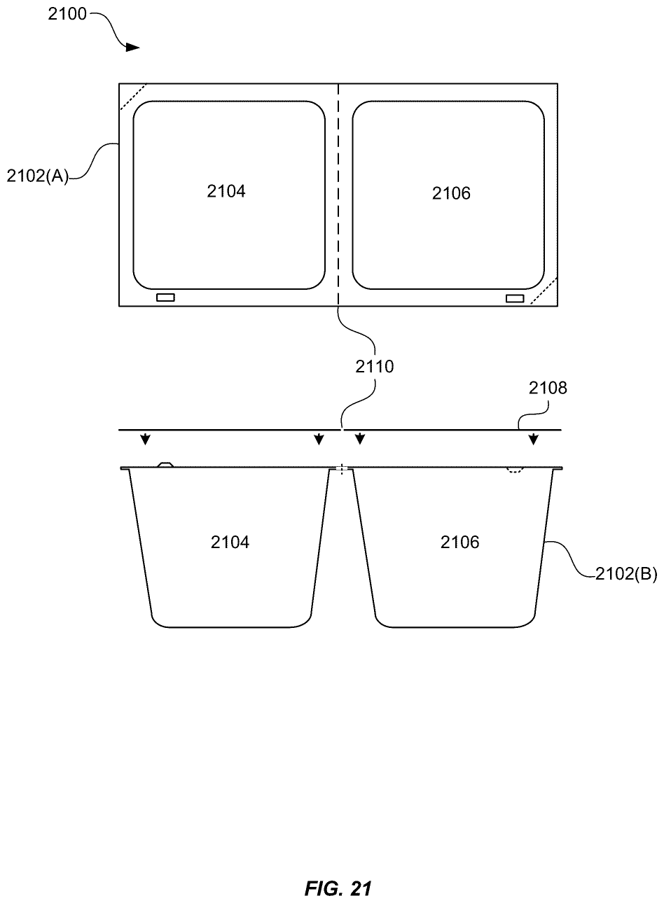

FIG. 21 depicts an illustrative example in which the multi-compartment container 2100 is a clamshell package having a divider in accordance with examples that can be suitable for packaging dry or wet products. The multi-compartment container 2100 may be an example of the clamshell packaging 1510 of FIG. 15. Numerous views of the multi-compartment container 2100 are presented. more particularly, FIG. 21 depicts a top-down view 2102(A) of the multi-compartment container 2100, as well as a side view 2102(B) of the multi-compartment container 2100. In some examples, the clamshell packaging 1510 may not include a hinge but may have a lid that covers the openings of the multiple compartments, in a manner similar to the trays of FIG. 18.

By using an appropriate plastic or other polymer, multi-compartment container 2100 can be used to package or contain various types of liquids and wet products that require special handling or an airtight seal to maintain usefulness. Compartments 2104 and 2106 can be sealed by an additional and separately openable seals, such as one time use foil or plastic seals, which may be applied to the multi-compartment container 2100 at the packaging facility. In some examples, the compartments 2104 and 2106 may be sealed using a single sheet of film 2108 affixed to a lip surrounding each of the respective compartments. The sheet of film 2108 may include a perforation 2110 which enables the film to be removed from one compartment without being removed from the other compartment(s). Additionally, by using a clear plastic in the construction of the multi-compartment container 2102, a consumer (or other person) can visually ascertain a status of the contents of the multi-compartment container 2102. In some examples, both the multi-compartment container 2102 itself and the film 2108 may be perforated as depicted at 2110.

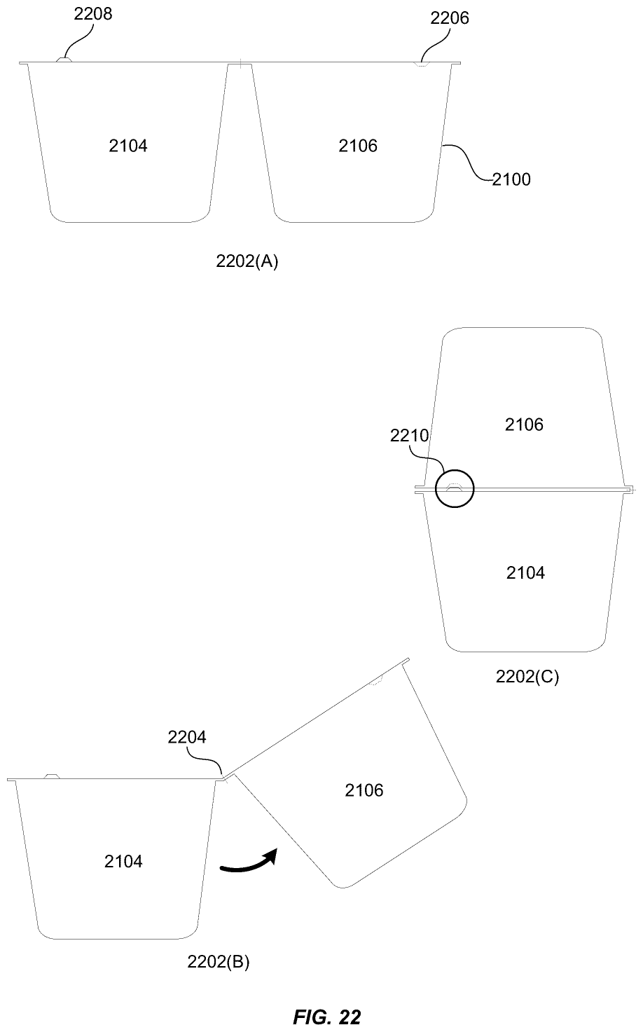

FIG. 22 depicts an illustrative example of a technique by which the multi-compartment container 2100 of FIG. 21 may be manipulated to provide for more secure storage in accordance with at least some examples. More particularly, FIG. 22 depicts a series of positions 2202 in which the multi-compartment container 2100 may be put in order to achieve different objectives.

As depicted at 2202(A), the multi-compartment container 2100 may be positioned such that either compartment 2104 or 2106 may be accessed by a user. In this position, it is envisioned that a user may be capable of removing the film 2108 from one or more of the compartments in order to consume the contents of that compartment. Whether the contents have been removed from the compartments or not, the multi-compartment container 2100 may be moved to position 2202(B) by pivoting one of the compartments around a hinge 2204. The first compartment 2014 and the second compartment 2106 may be attached via the hinge 2204 such that the first compartment 2104 is configured to rotate relative to the second compartment 2106. In some examples, the first compartment 2104 and the second compartment 2106 may each be sealed by a film covering. The film covering may include perforations between the first compartment 2104 and the second compartment 2106 to independently seal each of the first compartment 2104 and the second compartment 2106. The hinge 2204 may be a living hinge, formed of the materials of the multi-compartment container 2100, be integral, secured, fastened, removable, or otherwise connected to the multi-compartment container 2100. This movement may be continued until position 2202(C) is achieved. In position 2202(C), a user may be prevented from easily accessing either of the compartments 2104 or 2106. This position of the multi-compartment container 2100 may also prevent inadvertent removal of the film 2108 which forms the seal on either compartment. The hinge 2204, or a portion of the multi-compartment container 2100 between the first compartment 2104 and the second compartment 2016 may include perforations such that the first compartment 2014 is configured to detach from the second compartment 2106.

In some examples, the multi-compartment container 2100 may include a locking mechanism or locking device designed to keep the multi-compartment container 2100 in position 2202(C). The locking device may resist rotation of the first compartment 2104 relative to the second compartment 2106. Such a locking mechanism may include a cavity 2206 such as a recess, which may be formed as a recess in the lip around a perimeter of the multi-compartment container 2100 adjacent the second compartment 2106, and protrusion 2208 adjacent the first compartment 2104 capable of forming a lock 2210. The protrusion 2208 may be releasably secured in the cavity 2206. In such a lock 2210, the protrusion 2208 may be inserted into the cavity 2206 and may “snap” into place when position 2202(C) is achieved. The protrusion 2208 may be releasably secured in the recess, e.g., cavity 2206 when the locking device is engaged. When the locking mechanism is engaged, the multi-compartment container may be retained in a closed configuration. This may provide resistance to removing the multi-compartment container 2100 from position 2202(C), which may also prevent an inadvertent opening of one of compartments 2104 or 2106 or rotation of components of the multi-compartment container 2100 relative to one another.

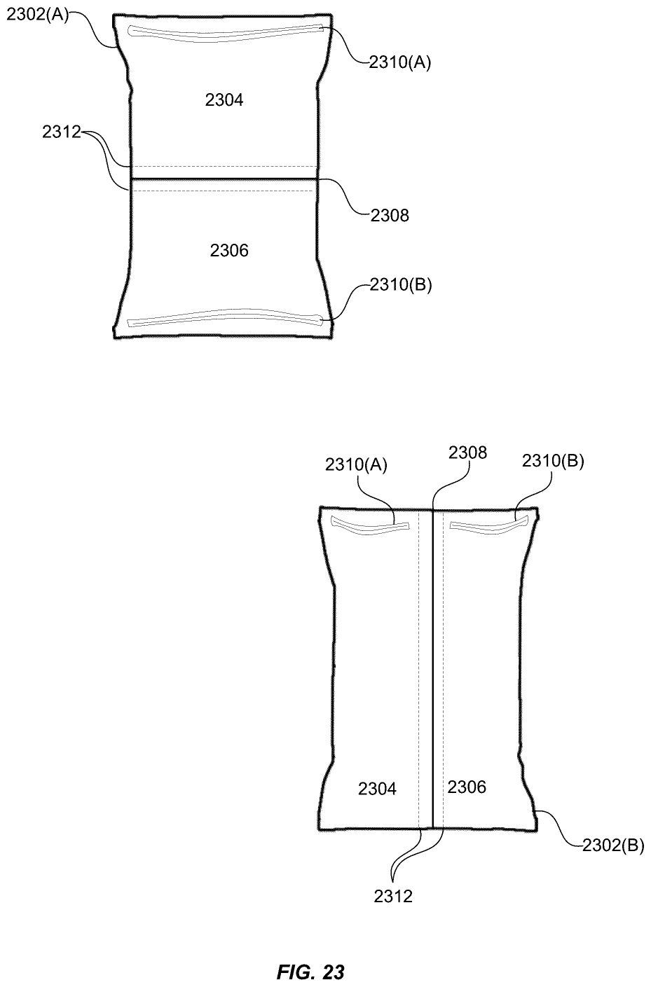

FIG. 23 depicts an illustrative example in which the multi-compartment container is a bag having a divider wall in accordance with examples. The multi-compartment containers 2302(A) and 2302(B) shown in FIG. 23 may be an example of the bags 1512 of FIG. 15. Depicted in FIG. 23 are separate versions of a multi-compartment container which may be implemented as a bag. These separate versions include 2302(A) and 2302(B) (collectively multi-compartment container 2302). Multi-compartment container 2302 can have sides or walls made of any suitable pliable material, e.g., a non-rigid or semi-rigid material for containing and maintaining freshness of the intended contents. For example, the material of the non-rigid or semi-rigid walls of multi-compartment container 2302 can be plastic, plastic film, Mylar™, foil, paper or biodegradable or compostable cellulose or combination thereof. The material of the walls or sides of multi-compartment container 2302 can include any type of flexible, pliable, non-rigid, or semi-rigid material.

As shown, multi-compartment container 2302 can have at least a first compartment 2304 and a second compartment 2306. In some examples, compartments 2304 and 2306 can be formed by crimping, sewing, or heat welding the non-rigid or semi-rigid walls of multi-compartment container 2302 at divider 2308 which may serve as a divider wall. Multi-compartment container 2302 can have a top and/or bottom end seam, which is sealed in the same manner. The seam may be a first seam providing access to a first compartment while a second seam provides access to a second compartment. As depicted in 2302(A), the divider 2308 may divide the multi-compartment container 2302 horizontally, resulting in compartments 2304 and 2306 being arranged vertically. In other examples, divider 2308 can be oriented in the longitudinal direction, such that the divider 2308 lies between, and perpendicular to, seals 2310, resulting in compartments 2304 and 2306 being arranged horizontally as depicted in 2302(B). It should be noted that arranging a divider in a longitudinal direction, as depicted in 2302(B), would result in a package which is easier to place on a retail shelf. In some examples, one or more compartments (2304 and/or 2306) can include re-closable seams or seals 2310 (e.g., 2310(A) and 2310(B)), such as zipper-type or reusable adhesive-type closures, which allow access to the respective compartment. In some examples the compartments 2304 and/or 2306 may not include re-sealable seals 2310 and may include a single use seal instead that is cut or torn away.

As in other examples, compartments 2304 and 2306 can be used to contain or package the same or different materials from one another. Divider 2308 can be formed in multi-compartment container 2302 to define separate compartments 2304 and 2306. As such, multi-compartment container 2302 can include compartments 2304 and 2306 as two separately openable pouches each having a separate portion of product therein. Divider 2308 can be formed by crimping, sewing, welding or adhering the walls of multi-compartment container 2302 to one another to form two compartments 2304 and 2306. In some examples, divider 2308 can include perforations 2312 along a length of the divider 2308 that can be used to detach one of the compartments from the other compartments once the contents of the compartment are depleted. In some examples, the perforations may enable separating the first compartment and the second compartment along the divider 2308. In some examples, the divider 2308 may have a width with a single perforation down a center portion of the divider 2308 to separate the components. In such examples, the multi-compartment container 2302 can be reduced in size as the contents are used to save storage space and for the convenience of the user. Accordingly, users (e.g., consumers) can open and access the contents of each compartment or pouch individually, while maintaining the freshness of the contents of the other pouch until the contents of the first pouch are depleted.

Multi-compartment container 2302 can be used to package various types of materials, products and foodstuffs. For example, multi-compartment container 2302 can be used to package foods such as product, vegetables, potato chips, pretzels, nuts, hot dogs, salad and other foods that are susceptible to spoilage or staleness upon exposure to oxygen and moisture. Alternatively, multi-compartment container 2302 can be used to package refill portions of regularly used household goods such as dish, laundry and hand soap, as well as condiments such as ketchup mustard or mayonnaise. In such examples, the use of a multi-compartment container 2302 can help reduce the amount of packaging required for distributing regularly used household goods while also providing users and consumers with an economical quantity discount.

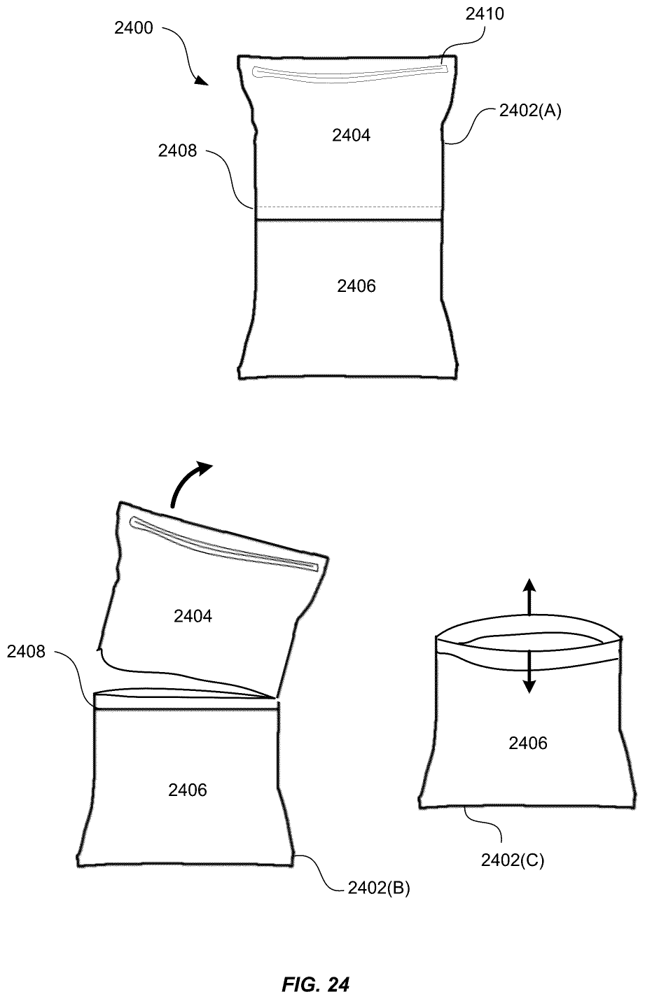

FIG. 24 depicts an illustrative example of an example of a multi-compartment container 2400 in accordance with some examples. In such examples, multi-compartment container 2400 can include compartments 2404 and 2406 that can contain a portion of some content. Each compartment 2404 and 2406 may be separated from one another by divider 2408, as described above in references to FIG. 23.

In some examples, the multi-compartment container 2400 may include a re-closable seam providing access to compartment 2404, such as seal 2410. The multi-compartment container 2400 may include a perforation 2408 that enables the compartment 2404 to be removed from the multi-compartment container 2400 as depicted at 2402(B). In some examples, the divider 2408 of the multi-compartment container 2400 may be formed of a re-closable seam or seal 2410, such that once the first compartment 2404 has been removed from the multi-compartment container 2400, the second compartment 2406 may be accessed via that divider 2408. For example, the re-closable seam at the divider 2408 may be pulled apart to access the compartment 2406. In some examples, a user may be required to cut or slice open the re-closable seam at the divider 2408.

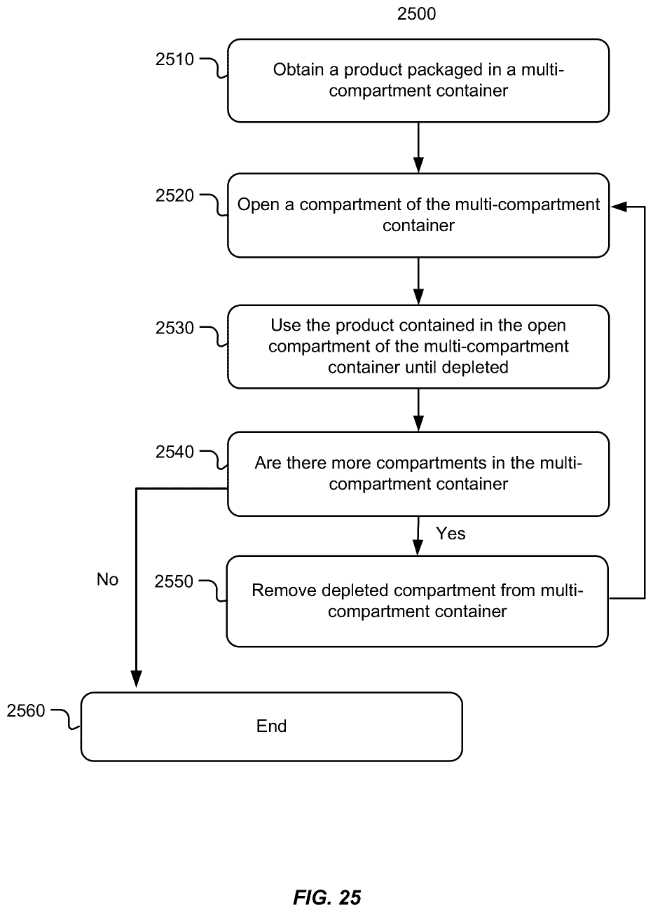

FIG. 25 depicts a flowchart of a method 2500 for using a multi-compartment container according to various examples. At step 2510, the consumer can obtain a product packaged in a multi-compartment container. In some examples, obtaining a packaged product having a multi-compartment container includes buying a product at a store or ordering a product online, while in other examples, the user can reuse a multi-compartment container refilled with the contents of his or her choice.

At step 2520, a user can open one of the compartments of the multi-compartment container as described in reference to the figures above. The contents of the first compartment of the multi-compartment container can be used either all at once or incrementally, as the contents of the multi-compartment container are needed. If the contents of the multi-compartment container are being used incrementally, the time required to complete the contents of the first compartment may be such that if the entirety of the contents of the container were exposed to air and moisture, the quality, freshness or potency of the contents might be compromised if it were not sealed in the second compartment.

In step 2530, a user can use the product contained in the first compartment of the multi-compartment container until it is depleted. At this point the user may determine if there are any remaining unopened compartments of the multi-compartment container. If so, then the user may, at step 2550, remove the depleted compartment from the multi-compartment container. For example, the user may tear the depleted compartment from the multi-compartment container via a perforation included on such.

The method may then return to 2520 and the user can open a second compartment of the multi-compartment container. The contents of the second compartment of the multi-compartment container can then be used until it is depleted. Once the product contained in the second compartment of the multi-compartment container is depleted, the user can then use any other available compartments of the multi-compartment container still containing product. This is the case if the multi-compartment container includes more than two separate compartments. The user can repeat steps 2520 through 2540 until no product remains in any compartments of the multi-compartment container.

At step 2560, Once all contents of the multi-compartment container are depleted (e.g., there is not another compartment of the multi-compartment container that still contains product), the user can discard, reuse or recycle the multi-compartment.

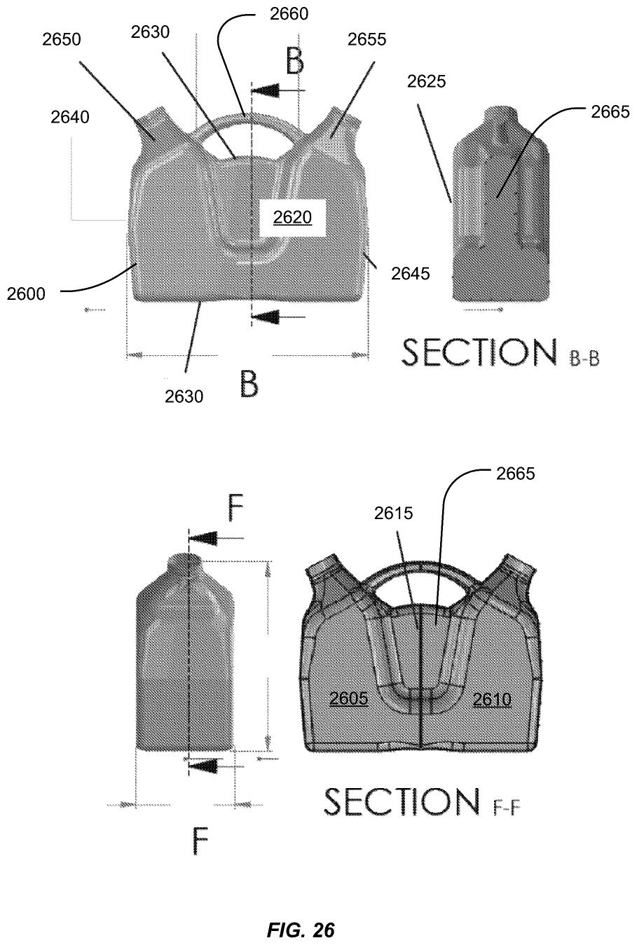

FIG. 26 shows views of a multi-compartment container 2600 according to some examples. The multi-compartment container 2600 may be used for any of the purposes described herein. For example, the multi-compartment container 2600 may be used for holding fluids, including perishable fluids, such as milk, juice, cooking oil, combinations thereof, and the like. In one example, one compartment of the multi-compartment container 2600 may hold one material, such as regular milk, while another compartment of the multi-compartment container 2600 may hold another material, such as chocolate milk. However, dry goods, such as breakfast cereal, flour, sugar, etc. may be stored in the multi-compartment container 2600. The multi-compartment container 2600 may be made of any of the materials discussed herein, combinations thereof, and the like. For example, the multi-compartment container 2600 may be constructed from a polymer, paper, fiber, and/or metal material by such techniques as molding, casting, stamping, bonding, welding, 3D printing, combinations thereof, and/or the like. In some examples, the multi-compartment container 2600 may be made of a liquid proof material.

The multi-compartment container 2600 may include a first compartment 2605 separated from a second compartment 2610. In some examples, the first compartment 2605 may be fluidly separated from the second compartment 2610 (i.e., the divider 2615 is impermeable to liquid). The first compartment 2605 may be separated from the second compartment 2610 by a divider 2615. The divider 2615 may be internal to the multi-compartment container 2600 in some examples. In some examples, the divider 2615 may be partially external to the multi-compartment container 2600, e.g., creating a rib on the outside of the multi-compartment container 2600, such that the divider 2615 is evident upon external inspection of the multi-compartment container 2600. For example, such examples may make it clear to consumers that the multi-compartment container 2600 indeed includes more than one separate compartment. Although shown and described as being vertically oriented, it is contemplated that the divider 2615 may be in any orientation, e.g., horizontal, vertical, at an angle, etc., and in any suitable shape. The divider 2615 may be made of the same or a different material than the remainder of the multi-compartment container 2600. In some examples, the multi-compartment container 2600 may be contoured inward, i.e., have a smaller depth along at least a portion of the multi-compartment container 2600 between the first compartment 2605 and the second compartment 2610, as shown in section B-B, which is a front or back-facing cross-section of the multi-compartment container 2600 about axis B. This area 2665 of lesser depth of the multi-compartment container 2600 may or may not form a part of the first compartment 2605 and the second compartment 2610. As shown in section F-F, which is a lateral cross-section of the multi-compartment container 2600 about axis F, this area 2665 of lesser depth may form a part of the first compartment 2605 on one side of the divider 2615, and form a part of the second compartment 2610 on the other side of the divider 2615. In some examples, this area 2665 of lesser depth may be solid, i.e., not hollow, such that it cannot hold a product therein.

In some examples, the compartments 2605, 2610, may each hold half of a typical consumer volume container. For example, each compartment 2605, 2610 may hold a half gallon of contents, for a total of one gallon of contents in the multi-compartment container 2600. In another example, each compartment 2605, 2610 may hold a liter of soda, for a total of two liters of soda in the multi-compartment container 2600. However, each compartment 2605, 2610 may hold any volume of contents, including different volumes of contents in each compartment. In other words, although each volume is shown to be approximately equal in FIG. 26, it is contemplated that the volumes of each compartment 2605, 2610 may be different. In addition, although shown as having two compartments, separated by one divider 2615, it is contemplated that the multi-compartment container 2600 may include any number of compartments separated by any number of dividers.

The multi-compartment container 2600 may include several external surfaces. In some examples, the external surfaces may be continuously and/or seamlessly joined. The external surfaces may include a front surface 2620 opposite a rear surface 2625, a bottom surface 2630 opposite a top surface 2635, and lateral surfaces 2640, 2645 opposite to one another. In some examples, the front surface 2620 and the rear surface 2625 may have non-uniform or non-planar surface structures in order to reduce internal volume of the multi-compartment container 2600. The divider 2615 may be at least partially internal to these external surfaces, as described above.

A first spout 2650 may be connected to the first compartment 2605, e.g., fluidly connected. The first spout 2650 may include a first closure, such as a twist off cap or seal, that is single use or reusable. In some examples, the first spout 2650 may include more than one closure, such as a single use closure covered by a reusable closure. In some examples, the first closure may fluidly seal the first compartment 2605.

A second spout 2655 may be connected to the second compartment 2610, e.g., fluidly connected. The second spout 2655 may include a second closure, such as a cap or seal, that is single use or reusable. In some examples, the second spout 2655 may include more than one closure, such as a single use closure covered by a reusable closure. In some examples, the second closure may fluidly seal the second compartment 2610.

In some examples, a handle 2660 may connect the first spout 2650 to the second spout 2655, while being elevated above the top surface 2635 such that a gap is present between the handle 2660 and the top surface 2635. In some examples, the handle 2660 may be formed from depressions in the front surface 2620 and the rear surface 2625 without creating a gap. The handle 2660 may be hollow and include an extension of the divider 2615 so as to prevent mixing of the contents of the first compartment 2605 and the second compartment 2610. In some examples, the handle may be internally solid so as to prevent mixing of the contents of the first compartment 2605 and the second compartment 2610.

The above description is illustrative and is not restrictive. Many variations will become apparent to those skilled in the art upon review of the disclosure.

One or more features from any example may be combined with one or more features of any other example without departing from the scope of the description. For example, any of the above-described multi-compartment containers can be combined with any other suitable example or type of multi-compartment container in any suitable manner in methods or systems according to examples described herein. As an illustration, a multi-compartment container can have a first box type compartment and second bag type compartment. Alternatively, one compartment can have plastic or composite walls to contain wet products while the attached second compartment can have cardboard walls to contain dry products.

A recitation of “a”, “an” or “the” is intended to mean “one or more” unless specifically indicated to the contrary.

1. A multi-compartment storage device, comprising:
a container body comprising:
a first surface extending from a first end to a second end and defining, at least in part, a first compartment;
a second surface extending from a third end to a fourth end and defining, at least in part, a second compartment adjacent the first compartment; and
a divider wall positioned adjacent the second end and the third end and defining, at least in part, the first compartment and the second compartment, wherein:
each of the first compartment and the second compartment is independently accessible;
the first surface comprises first perforations adjacent the second end configured to enable at least a portion of the first surface to be separated from the divider wall;
the second surface comprises second perforations adjacent the third end configured to enable at least a portion of the second surface to be separated from the divider wall;
a first seal coupled to the first compartment; and
a second seal coupled to the second compartment, wherein:
at least one of the first seal or the second seal is a reusable closure element configured to be accessed without breaking the other seal.

2. The multi-compartment storage device of claim 1, wherein the first surface comprises a first material and the second surface comprises the first material.

3. The multi-compartment storage device of claim 1, wherein the first surface comprises a first material and the second surface comprises a second material, wherein the first material is different from the second material.

4. The multi-compartment storage device of claim 1, wherein the first seal comprises a first resealable zip closure.

5. The multi-compartment storage device of claim 4, wherein the second seal comprises a first resealable zip closure.

6. The multi-compartment storage device of claim 1, wherein the container body comprises at least one of a polymer, a plastic film, a foil, or a mylar.

7. The multi-compartment storage device of claim 1, further comprising first pleats at the first end adjacent the first seal, second pleats at the fourth end adjacent the second seal, and third pleats at the divider wall.

8. The multi-compartment storage device of claim 1, wherein a first surface area of the first surface is within substantially the same as a second surface area of the second surface.

9. The multi-compartment storage device of claim 1, wherein a first surface area of the first surface is different from a second surface area of the second surface.

10. The multi-compartment storage device of claim 1, wherein the divider wall comprises a first layer coupled to the first surface and a second layer coupled to the second surface.

11. The multi-compartment storage device of claim 1, wherein the divider wall is oriented perpendicular to an axis extending from the first end to the fourth end.

12. The multi-compartment storage device of claim 1, wherein the first compartment, second compartment, and divider wall comprise a unitary body.

13. A method of using a multi-compartment storage device comprising:
obtaining the multi-compartment storage device, wherein the multi-compartment storage device comprises:
a first surface extending from a first end to a second end and defining, at least in part, a first compartment;
a second surface extending from a third end to a fourth end and defining, at least in part, a second compartment adjacent the first compartment; and
a divider wall positioned adjacent the second end and the third end and defining, at least in part, the first compartment and the second compartment, wherein:
each of the first compartment and the second compartment is independently accessible;
the first surface comprises first perforations adjacent the second end configured to enable at least a portion of the first surface to be separated from the divider wall;
the second surface comprises second perforations adjacent the third end configured to enable at least a portion of the second surface to be separated from the divider wall;
a first seal coupled to the first compartment; and
a second seal coupled to the second compartment, wherein:
at least one of the first seal or the second seal is a reusable closure element configured to be accessed without breaking the other seal;
opening the first seal;
accessing and using product stored in the first compartment;
removing the first compartment from the second compartment by separating the first surface at the first perforations; and
opening the second seal and using product stored in the second compartment.

14. The method of claim 13, wherein opening the first seal comprises opening a resealable zip closure.

15. A product container comprising:
a first surface extending from a first end to a second end and defining, at least in part, a first compartment;
a second surface extending from a third end to a fourth end and defining, at least in part, a second compartment adjacent the first compartment; and
a divider wall positioned adjacent the second end and the third end and defining, at least in part, the first compartment and the second compartment, wherein:
each of the first compartment and the second compartment are independently accessible;
the first surface comprises first perforations adjacent the second end configured to enable at least a portion of the first surface to be separated from the divider wall;
the second surface comprises second perforations adjacent the third end configured to enable at least a portion of the second surface to be separated from the divider wall;
a first seal coupled to the first compartment; and
a second seal coupled to the second compartment, wherein at least one of the first seal or the second seal is a reusable closure element configured to be accessed without breaking the other seal.

16. The product container of claim 15, wherein the first seal comprises a first resealable zip closure.

17. The product container of claim 15, wherein the second seal comprises a first resealable zip closure.

18. The product container of claim 15, wherein the divider wall comprises a first layer coupled to the first surface and a second layer coupled to the second surface.

19. The product container of claim 15, wherein the divider wall is oriented perpendicular to an axis extending from the first end to the fourth end.

20. The product container of claim 15, wherein the first compartment, second compartment, and divider wall comprise a unitary body.
